(19) United States
(12) Patent Application Publication
(10) Pub. No.: US 2004/0078271 A1
(43) Pub. Date: Apr. 22, 2004

(54) Method and system for tax reporting

(75) Inventors: David Morano, Ridgewood, NJ (US); Ray Miranda, Monsey, NY (US); Dindo Bautista, Dayton, NJ (US)

Correspondence Address: PILLSBURY WINTHROP, LLP, P.O. BOX 10500, MCLEAN, VA, 22102, US

(73) Assignee: UBS PaineWebber Inc., Weehawken, NJ

(21) Appl. No.: 10/272,379

(22) Filed: Oct. 17, 2002

(51) Int. Cl. G06F 17/60

(52) U.S. Cl. 705/19

(57) ABSTRACT

A system and method for tax reporting of taxable and non-taxable distributions, gains and losses of investments including providing access to tax information regarding the investments and providing various functions pertaining to the tax information is provided. The system and method can be used by, among others, financial institution personnel to view and adjust tax information on tax forms, such as the United States Internal Revenue Service (IRS) 1099, 1042S and 480.6A,B,C forms. The system and method can be used to perform tax reporting for any number of kinds of tax information and investment information, including tax information associated with investments in any kind of banking or trust account such as checking, savings, lines of credit, home equity loans, mortgages, trust accounts, and certificate of deposit, creditor accounts such as credit card accounts and loans, and employment-related accounts such as employer loans and employee stock purchase plans.

### BACKGROUND

Each year many financial institutions process the tax reporting of taxable and non-taxable distributions, gains and losses of investments held by the financial institutions on its own or its customer's behalf. For example, financial institutions in order to comply with United States tax reporting laws and regulations provide their customers with specific tax forms, such as 1099, 1042S, 480.6A,B,C and others forms, that provide tax and investment information with respect to the customers' investments held in one or more accounts with the financial institution. Such investments can be virtually any type of security including stocks, bonds, mutual funds, and investment certificates. The accounts can include any kind of investment, banking or trust account such as brokerage accounts, checking accounts, savings accounts, loans and mortgages, trust accounts, certificates of deposit, credit card accounts, and employment-related accounts such as 401K and employee stock purchase accounts.

In financial institutions, most, if not all, of the relevant tax and investment information necessary to prepare tax forms for the financial institutions' customers, which includes individuals, trusts, estates, corporations and partnerships, is available electronically and capable of being transmitted and processed by electronic means such as computers. However, in many cases, financial institutions have disparate systems for maintaining tax and investment information where, in each system, the tax and investment information is often formatted differently. Further, the tax and/or investment information data is often assembled annually at the beginning of each year when the tax forms must be distributed to the financial institutions' customers. At that time, the data is often manipulated to update stale information, to correct errors and to apply security reclassifications or other global updates. Further, the tax information is typically assembled into aggregate amounts of, for example, dividends or interest paid in an account.

The result is that the actual preparation of the tax forms from that tax and investment information can often be, among other things, difficult, labor-intensive, time-consuming and error-prone. For example, the annual assembly of the aggregate data can often lead to tax forms inaccurately reporting tax and/or investment information where changes occur to the tax and/or investment information after the assembly of the data but before the distribution of the forms, such as, for example, a changed customer tax identification number or updated customer address. Further, the use of aggregate data does not lend itself to global adjustments with respect to particular securities, such as addition, deletion or reclassification of a particular payment related to the securities. Moreover, aggregate data is often not useful for resolution and explanation of questions on customers' tax related information.

Accordingly, it would be advantageous to provide improved tax reporting methods and systems.

### BRIEF DESCRIPTION OF THE DRAWINGS

Utility of the embodiments of the invention will be readily appreciated and understood from consideration of the following detailed description of embodiments of this invention, when taken with the accompanying drawings, in which same numbered elements are identical or similar and:

FIG. 1 illustrates a networked enviromnent in which at least one embodiment according to the present invention may be implemented;

FIG. 2 illustrates a schematic system view of at least one embodiment according to the present invention;

FIG. 3 illustrates a functional block diagram of a server in at least one embodiment according to the present invention.

FIG. 4 illustrates a functional block diagram of the software and top-level process flow of at least one embodiment according to the present invention;

FIG. 5 illustrates a functional block diagram of the data flow of at least one embodiment according to the present invention;

FIG. 6 illustrates a flowchart of the login and screen access of at least one embodiment of the present invention;

FIG. 7 illustrates a flowchart of the generation of the screens and/or store of data of at least one embodiment of the present invention;

FIG. 8 depicts a hierarchical layout of the menu structure of the screens of at least one embodiment of the present invention;

FIG. 9 illustrates an implementation of an account profile screen in accordance with at least one embodiment of the invention;

FIG. 10 illustrates an implementation of a 1099-DIV summary tax form screen in accordance with at least one embodiment of the invention;

FIG. 11 illustrates an implementation of a 1099-DIV details tax form screen in accordance with at least one embodiment of the invention;

FIG. 12 illustrates an implementation of a 1099-INT summary tax form screen in accordance with at least one embodiment of the invention;

FIG. 13 illustrates an implementation of a 1099-INT details tax form screen in accordance with at least one embodiment of the invention;

FIG. 14 illustrates an implementation of a 1099-OID summary tax form screen in accordance with at least one embodiment of the invention;

FIG. 15 illustrates an implementation of a 1099-B summary tax form screen in accordance with at least one embodiment of the invention;

FIG. 16 illustrates an implementation of a 1099-B details tax form screen in accordance with at least one embodiment of the invention;

FIG. 17 illustrates an implementation of a 1099-MISC summary tax form screen in accordance with at least one embodiment of the invention;

FIG. 18 illustrates an implementation of a Non-Reportable Income summary screen in accordance with at least one embodiment of the invention;

FIG. 19 illustrates an implementation of a 1042S (Income Subject to Withholding) summary tax form screen in accordance with at least one embodiment of the invention;

FIG. 20 illustrates an implementation of a 1042S (Non-Reportable Income) summary tax form screen in accordance with at least one embodiment of the invention;

FIG. 21 illustrates an implementation of a 480.6A (Income Not Subject to Withholding) summary tax form screen in accordance with at least one embodiment of the invention;

FIG. 22 illustrates an implementation of a 480.6B (Income Subject to Witholding) summary tax form screen in accordance with at least one embodiment of the invention;

FIG. 23 illustrates an implementation of a 480.6C (Income Subject to Withholding—Nonresidents) summary tax form screen in accordance with at least one embodiment of the invention;

FIG. 24 illustrates an implementation of a Reclass/Global Maintenance Type of Reclass screen in accordance with at least one embodiment of the invention;

FIG. 25 illustrates an implementation of a Reclass/Global Maintenance Payment History screen in accordance with at least one embodiment of the invention;

FIG. 26 illustrates an implementation of a Reclass/Global Maintenance Add Reclass screen in accordance with at least one embodiment of the invention; and

FIG. 27 illustrates an implementation of a 1099-B Edit screen in accordance with at least one embodiment of the invention.

### DETAILED DESCRIPTION

At least one embodiment of the invention provides a system and method for tax reporting of taxable and non-taxable distributions, gains and losses of investments including providing access to tax information regarding the investments and providing various functions pertaining to the tax information. In at least one embodiment, the system and method facilitates United States Internal Revenue Service (IRS) tax reporting. The system and method can be used by, among others, financial institution personnel to view and adjust tax information on tax forms, such as the IRS 1099, 1042S and 480.6A,B,C forms. The system and method can be used to perform tax reporting for any number of kinds of tax information and investment information, including tax information associated with investments in any kind of investment, banking or trust account such as brokerage accounts, checking accounts, savings accounts, loans and mortgages, trust accounts, certificates of deposit, credit card accounts, and employment-related accounts such as 401K and employee stock purchase accounts. Those skilled in the art will recognize that many variations are possible in which the system and method for tax reporting may be configured to provide tax reporting functionality within the scope of the present invention. The systems and methods described herein may be applied to any financial or credit instruments in which transactions involving one or more such instrument may be assigned an economic or monetary value, or in which an investor's current position involving one or more such instruments may be assigned an economic or monetary value.

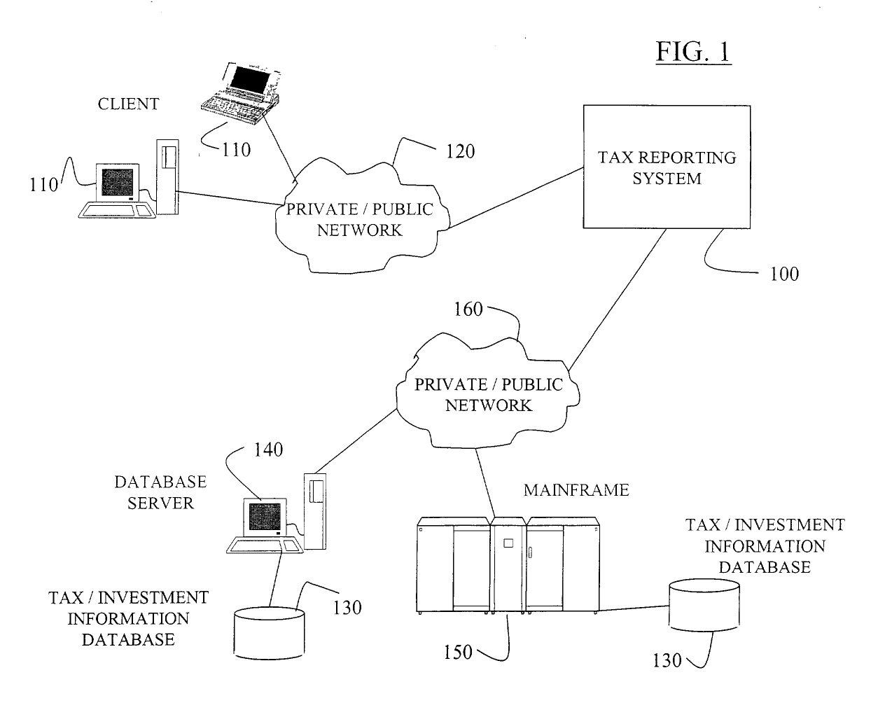

FIG. 1 illustrates a networked environment in which at least one embodiment according to the present invention may be implemented. Tax reporting system 100 processes and transmits tax information and where applicable, related investment information. The network environment comprises one or more clients 110 that may send tax information requests and/or update commands to the tax reporting system via a client communications interface 120, and that may receive tax and/or investment information from the tax reporting system using the client communications interface. The networked environment further comprises one or more tax information databases 130, managed or housed by, for example, a database server 140 or mainframe 150, that may receive tax information queries and/or updates from the tax reporting system via a database information communications interface 160, and that may transmit tax information responses to the tax reporting system queries and/or updates using the database information communications interface. In at least one embodiment, the networked environment may further comprise one or more investment information databases 130, managed or housed by, for example, a database server 140 or mainframe 150, that may receive investment information queries from the tax reporting system via the database information communications interface, and that may transmit investment information responses to the tax reporting system queries using the database information communications interface. Such tax information and investment information databases include traditional relational databases in a financial institution such as, but not limited to, a brokerage firm or bank, that store typical tax and/or investment information of the institution, the institution's customers, etc. Although shown in FIG. 1 as comprising separate physical computing platforms, the clients, database(s), tax reporting system, etc. may also be implemented in the form of application software instructions executing on a single computing platform as well as across multiple computing platforms. Further, although as shown as databases, the tax information and investment information databases may be other systems that provide or access tax and/or investment information.

The client(s) may be, for example, a web-enabled personal computer provided with the capability to receive and display user interfaces included on, for example, HyperText Markup Language (HTML) formatted or Extensible Markup Language (XML) formatted pages, private network (e.g., intranet) pages, etc., provided in accordance with, for example, the HyperText Transport Protocol (HTTP). The client(s) may also have the capability to transmit and receive electronic mail messages in accordance with the Simple Mail Transport Protocol (SMTP). The client(s) may also be any personal communication device such as, but not limited to, a personal digital assistant or a web-enabled wireless telephone.

The communications interfaces may include any type of communications network and may include communications connections within and/or outside the financial institution. In at least one embodiment, the communications network may be a public network such as the Internet. Communications systems used to implement the communications networks may include, but are not limited to, telephone landline based modem network, a wireless network such as a cellular digital packet data (CDPD) network or a wireless local area network (LAN) provided in accordance with, for example, the IEEE 802.11 standard. Additionally, the communications network may be a private network in which information transmitted over the communications network is prevented from being readily accessible by systems or persons other than those associated with or permitted by the tax reporting system. The communications network may use encryption, for example, the BSAFE® product available from RSA Security, Inc. of Bedford, Mass. Alternatively, data transmitted on the communications network may be encrypted using any other commercially available or proprietary encryption scheme such as, but not limited to, 56-bit Data Encryption Standard (DES), 128-bit triple-DES, 128-bit RC4 and IDEA. In accordance with at least one embodiment of the invention, the tax reporting system uses HTTP connections over its communications interfaces, which connections may conform to the Secure Socket Layer (SSL) protocol in order to provide for secure information transport for tax and investment information.

The databases may include a database management system (DBMS) software application such as DB2™ Universal Database, provided by IBM Corporation, for storage and retrieval of tax and investment information in accordance with the Structured Query Language (SQL) database format. In at least one embodiment, the database management software may execute one or more stored procedures or scripts of SQL instructions operative to store or retrieve particular items of tax and/or investment information arranged and formatted in accordance with a set of formatting instructions. Such stored procedures are typically stored or otherwise associated with the databases. As described in more detail below, for instance, the database management software may execute one or more SQL stored procedures in response to a request from the tax reporting system to receive particular items of tax and/or investment information in a format suitable for transmission to and display by the client(s) using a browser software application such as, for example, the Internet Explorer™ application provided by Microsoft Corporation. In at least one embodiment, the databases (and their database management software) may communicate with the tax reporting system in accordance with the Open Database Connectivity (ODBC) standard developed by Microsoft Corporation.

In at least one embodiment, the tax information and/or investment information is maintained in a relational database and formatted and arranged in accordance with a particular database management system standard such as SQL, in order to facilitate tax information and/or investment information storage and retrieval by the database management software. Tax information may include investment payment, distributions, gains and other transactions information, taxes paid information, commissions and fees information, etc. The investment information may include account details information, securities information, investment advisor information, etc. Certain items of tax information and/or investment information may be stored as encrypted information for purposes of maintaining the security of these items.

Although not shown in FIG. 1, a networked environment for use in conjunction with, including or implementing the tax reporting system may include multiple load-balanced servers, load balancers, back-up sites and facilities for restoration of information. The networked environment may further include one or more firewalls or proxies to facilitate, among other things, the security and integrity of the network. The networked environment may further include one or more of the following: a SSL accelerator to support secure networked communications, caching servers for local higher-speed serving of recently or frequently requested HTML or XML pages, one or more application server clusters, one or more web server clusters, one or more database server clusters, persistent storage, and switching devices. For example, the server clusters may be used to implement the tax reporting system in whole or in part and the persistent storage used to hold tax reporting system information. The network environment depicted in FIG. 1 may have further interfaces (not shown) to one or more other networks.

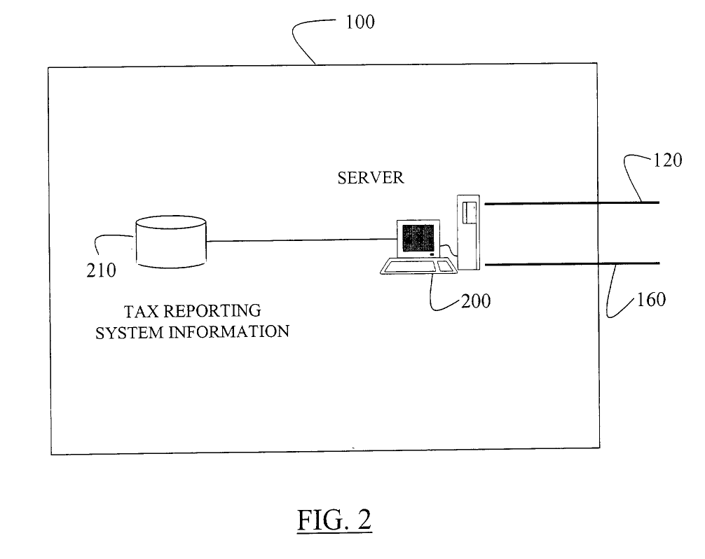

FIG. 2 illustrates a schematic system view of at least one embodiment according to the present invention. The tax reporting system comprises one or more servers 200 that may receive tax and/or investment information requests or updates from one or more clients via the client communications interface 120, and that may transmit tax information to the client(s) using the client communications interface. The server(s) may transmit tax information queries or updates to the tax information database(s) using the database communications interface, and that may receive tax information responses from the tax information database(s) via the database communications interface 160. The server(s) may also transmit investment information queries or updates to investment information database(s), where implemented, using the database communications interface, and that may receive investment information responses from those investment information database(s) via the database communications interface.

In at least one embodiment, the server(s) are one or more computers having software to provide a platform for the functions of the tax reporting system 100. In this respect and as described in more detail below, the server(s) may include software to interact with the client(s) via the client communications interface and may also include software to interact with the tax information database(s) and/or investment information database(s) via the database communications interface. As will be apparent to those skilled in the art, the server(s) may also interact with other systems and platforms through the above-described or other communications interfaces and have appropriate software therefor. For example, the tax reporting system may optionally provide communications interfaces from the server(s) to other tax information and/or investment information sources outside of the financial institution for the purposes of communicating tax and/or investment information with those other sources.

The server(s) may include application server software such as the WebSphere™ Application Server software product, provided by the IBM Corporation, for processing and transmission of tax and/or investment information as HTML or XML pages. Further, the server(s) may include database access software such as the DB2 Connect™ software product, provided by the IBM Corporation, to communicate with the database(s). The server(s) may also include software programmed in the Java™ programming language developed by Sun Microsystems, Inc. and/or the JavaScript™ programming language offered by Sun Microsystems, Inc., to provide tax reporting functionality. As will be apparent to those skilled in the art, other software products and programming languages may be used for implementation of the tax reporting system as described herein.

As will be apparent to those skilled in the art, the one or more servers of the tax reporting system may each provide different functionality of the tax reporting system. So, for example, the one or more servers of the tax reporting system may include a database server for managing database interaction, an application server for providing tax reporting functionality, and a web server for managing client interaction. Similarly, all functionality of the tax reporting system may be implemented in the form of software executing on one server. Further, portions of the tax reporting system may also be provided by other software, servers or systems in the networked environment. Also, the tax reporting system may include all or parts of the networked environment. Accordingly, the tax reporting system may implemented in any number of configurations.

Furthermore, the tax reporting system may include one or more other interfaces (not shown) to external systems and applications such as a tax reporting system of a tax authority such as the United States Internal Revenue Service. In such embodiments, the tax reporting system may include one or more asynchronous links to the tax authority's tax reporting system provided in accordance with the SSL protocol.

The tax reporting system may be implemented using an existing networked environment developed to facilitate the exchange of tax and/or investment information over networks and employ widely used, reliable components such as off-the-shelf server computers, server software and database software. The tax reporting system may use, for example, database software to store some or all information including persistence and database tables. The technology used may be chosen to provide flexibility, modularity, reliability, scalability, speed of execution and data security.

The tax reporting system may also comprise one or more databases 210 to store tax reporting system information. Such tax reporting system information can include local data generated during the operation of the tax reporting system, configuration parameters, copies of tax and/or investment information, etc. Such tax reporting system information may also comprise software code for the tax reporting system.

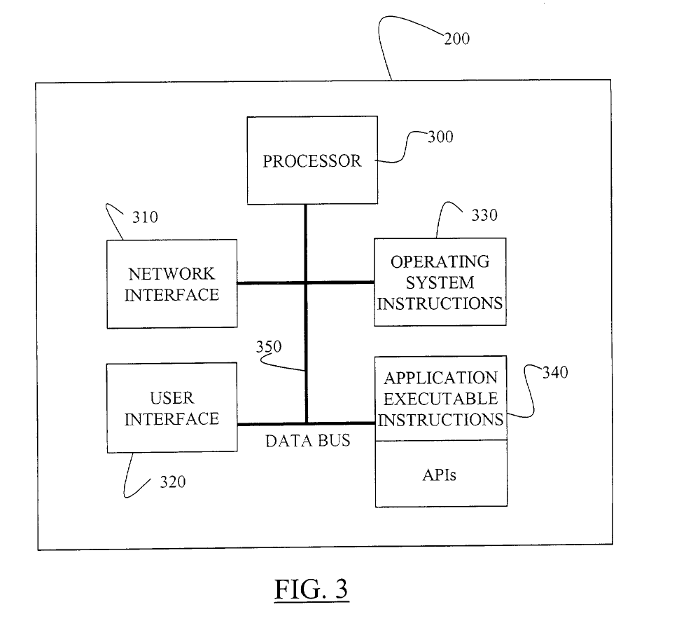

FIG. 3 is a functional block diagram of a server 200 useful for hosting software programs implementing one or more aspects of the tax reporting functionality of at least one embodiment according to the present invention. Referring to FIG. 3, the server includes a processor 300, a network interface 310, a user interface 320, operating system instructions 330, application executable instructions/API 340, all provided in functional communication using a data bus 350.

In at least one embodiment, the server may be a Sun Enterprise™ 420 server computer provided by Sun Microsystems, Inc. of Palo Alto, Calif. Processor 300 may be any microprocessor or microcontroller configured to execute software instructions implementing the functions described herein. In at least one embodiment, processor 300 may be four 450-MHz, 64-bit Sun UltraSPARC-II™ processors provided by Sun Microsystems of Palo Alto, Calif. and included as a component of the Sun Enterprise™ 420 server.

Application executable instructions/APIs 340 include software programs implementing one or more aspects of the tax reporting system functionality, as more fully discussed herein. The server may also be useful for hosting software application programs implementing the client(s). Application executable instructions/APIs 340 may also include one or more application program interfaces (APIs). The tax reporting system software programs may use APIs for inter-process communication and to request and return inter-application function calls. For example, an API may be provided to facilitate the development of SQL scripts useful to cause a database to perform particular data storage or retrieval operations in accordance with the instructions specified in the script(s). In general, APIs may be used to facilitate development of the software programs that accomplish the tax reporting system functionality described herein.

Operating system instructions 330 include software instructions operable to control basic operation and control of processor 300. In at least one embodiment, operating system instructions 330 may include the Sun Solaris™ 8 UNIX-based operating system configured for use with the Sun Enterprise™ 420 server.

Application executable instructions/APIs 340 and operating system instructions 330 are stored using server nonvolatile memory. Application executable instructions/APIs 340 and operating system instructions 330 are loaded into one or more allocated code segments of server volatile memory for runtime execution. In at least one embodiment, the server includes 2GB of volatile memory and 36GB of nonvolatile memory storage.

The network interface 310 may provide the server the capability to transmit and receive information, including but not limited to electronic mail, files, HTML pages and/or XML pages, over a network connection. The user interface 320 may include a computer terminal display, keyboard, and mouse device. One or more graphical user interfaces (GUIs) also may be included to provide for display and manipulation of data contained in, for example, interactive HTML or XML pages.

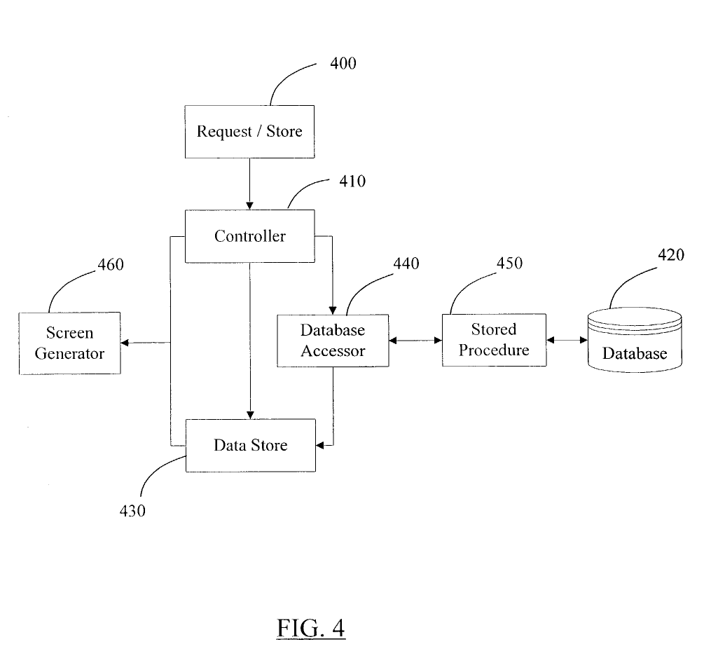

FIG. 4 illustrates a functional block diagram of the software and top-level process flow of at least one system embodiment according to the present invention. The server(s) may receive via the client communication interface a request 400 for particular information (and receive associated user-entered data from a client (such as a browser or electronic access device)) or a store command 400 for storing particular information (and receive associated user-entered data from a client (such as a browser or electronic access device)). In at least one embodiment, the request may be for tax and/or investment information formatted in a screen and the user-entered data includes data used to facilitate the retrieval of the requested tax and/or investment information. Such a request may be a hyperlinked request from a screen, comprising one or more interactive HTML or XML pages in accordance with the JavaServer Pages™ (JSP) format developed by Sun Microsystems, Inc., displayed on the client and the request transmitted according to the HTTP protocol. In at least one embodiment, the store command may be for a store operation performed in relation to user-entered data. Such a store command may be a hyperlinked command from a screen, comprising one or more interactive HTML or XML pages in accordance with the JavaServer Pages™ (JSP) format developed by Sun Microsystems, Inc., displayed on the client and the store command transmitted according to the HTTP protocol. The user-entered data may be data provided by a user through a screen, comprising one or more interactive HTML or XML pages in the JSP format, displayed on the client. A page generated using JavaServer Pages technology is a text-based document that contains two types of text: static template data, which can be expressed in any text-based format such as HTML or XML and JavaServer Pages elements, which construct dynamic content. Alternatively, such a request or store command may be a hyperlinked request or store command from a screen, comprising one or more interactive HTML or XML pages in accordance with the Active Server Pages™ (ASP) format developed by Microsoft Corporation, displayed on the client and the request or store command transmitted according to the HTTP protocol. In that case, the user-entered data may be data provided by a user through a screen, comprising one or more interactive HTML or XML pages in the ASP format, displayed on the client.

When the request or store command is received and processed by the server, a controller 410 is triggered to process the request or the store command (and the user-entered data, if any). In at least one embodiment, the controller is a servlet programmed in the Java programming language. The servlet initiates a database connection with one or more databases 130, 420 over the database communications interface. In at least one embodiment, the database(s) include a tax information and/or investment information database. The servlet further creates an instance of a data store 430 associated with the servlet that is used to hold the data processed and/or created by the servlet, by a database accessor 440 (described hereafter), and by one or more stored procedures 450 (described hereafter). In at least one embodiment, the data store is an instantiated data bean class written in the Java programming language. Once the data bean class is instantiated, the servlet invokes the database accessor to execute the stored procedure(s) associated with the database. In at least one embodiment, the database accessor is a data bean class written in the Java programming language. The servlet also passes information about the request or store command and the user-entered data, if any, to a screen generator 460 for use in display, as described in more detail below. In at least one embodiment, the screen generator is a JSP application.

As described above, the database access class is called by the servlet to execute one or more stored procedures associated with the database(s). In at least one embodiment, different stored procedures are provided to retrieve different sets of tax and/or investment information or store user-entered data and the servlet chooses the particular stored procedure(s) for execution based upon the request or store command. The stored procedure(s) is executed according to information passed by the servlet to the database access class to obtain the requested information or store the user-entered data. In at least one embodiment, the user-entered data and/or other information determined by the servlet is passed to the stored procedure(s) to retrieve requested tax information and/or investment information for a request and to store user-entered data for a store command. The data and information that is passed includes, for example, account ID and tax year. Once the stored procedure(s) has executed against the database(s), the requested information and/or other results, if any, of the stored procedure(s) are stored into the data bean instance created by the servlet. In at least one embodiment, the stored procedure(s) returns requested tax and/or investment information in accordance with the user entered data and/or other information passed to the stored procedure(s) by the servlet. In the case of a store command, the stored procedure(s) returns an error or confirmation message.

For user requests or store commands that may require further processing, the server(s) may perform a series of operations using the user-entered data, the requested information and/or other results, if any, received from the stored procedure(s). In at least one embodiment, the server may perform login operations and may perform calculations on tax and/or investment information returned from the stored procedure(s). The server(s) may execute one or more servlets, which may optionally be requested from another server in the tax reporting system, to perform such processing. The server(s) may also have and use additional information, stored on the server(s) or obtained from other sources, used to process such requests or store commands. In at least one embodiment, such additional information may include permission information.

As will be apparent to those skilled in the art, the controller, the database accessor, the data store, the screen generator and the stored procedure(s) may be implemented as a single software and/or hardware application or divided into any number of separate software and/or hardware applications or components. Further, any type of query mechanism can be used instead of a stored procedure(s) including one or more query scripts incorporated into or accessible by the database accessor.

The screen generator then facilitates display of all or some of the data held in the data bean by generating and transmitting a screen, comprising, for example, one or more interactive HTML or XML pages, to the client via the client communications interface. In at least one embodiment, a screen may be generated by the JSP application that comprises one or more interactive HTML or XML pages including and/or using information about the request, store command, the user-entered data, the requested tax information and/or investment information and/or other results, if any, and transmitted to the requesting client in accordance with JSP formatting and the HTTP protocol. Alternatively, the screen may be generated and transmitted in accordance with the ASP standard developed by Microsoft Corporation.

Optionally, the server may provide one or more applets to the client, the applets configured to run on a browser application executing on the client and to provide tax reporting system functionality on the client. For example, an applet may be provided in association with a screen of the tax reporting system displayed on the client to interact with the user of the client.

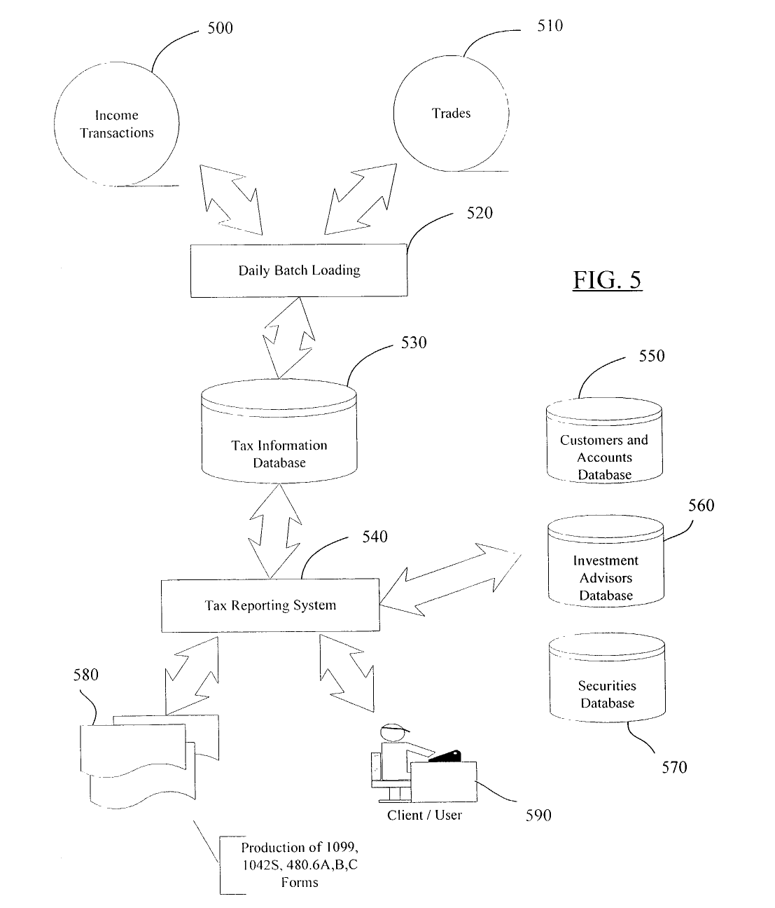

FIG. 5 illustrates a functional block diagram of the data flow in the networked environment and tax reporting system of at least one embodiment according to the present invention. Referring to FIG. 5, an income transactions system 500 and a trades system 510 transmit tax information to a daily batch loading process 520. The income transactions system records and maintains investment income information such as interest and dividends on securities. In at least one embodiment, the income transactions system is a mainframe application that records all the investment income for all accounts held by a financial institution on behalf of itself or others. The trades system records and maintains investment transactions information such as gains, losses and other proceeds from securities transactions. In at least one embodiment, the trades system is a mainframe application that records all the investment transactions gains, losses and other proceeds information for all accounts held by a financial institution on behalf of itself or others. As will be apparent to those skilled in the art, the income transactions and trades systems may be a collection of systems with securities income and transactions information.

In at least one embodiment, the tax information is transmitted daily to the daily batch loading process in one or more batch files by a file download, such as by a file transfer protocol (FTP) download over a communications network. In the daily batch process loading, the tax information is processed for loading into a tax information database 530. Such processing can include selecting the tax information necessary for the tax information database (and filtering out unneeded tax information), checking for errors and inconsistencies in the selected tax information, and formatting the selected tax information into appropriate records for the tax information database. Such data loading into the tax information database may be performed using a fastload utility of the IBM DB2 database software product. While the batch loading process is shown as a daily process, the loading may be performed on other schedules including real-time. Advantageously, daily (or shorter) loading allows for improved checking for and remedy of tax information errors throughout the tax year. Further, the tax information database may comprise the income transaction system and trades system themselves without need for a daily batch loading process where possible.

In at least one embodiment, the tax information transmitted to the daily batch process includes, in addition to aggregate tax information such as the amount of interest paid in an account or amount of dividends paid in an account, transactional tax information corresponding to the aggregate tax information. For example, the transactional tax information transmitted can include details of an aggregate dividend amount including identifiers of securities that paid dividends in the account and the specific amount(s) of dividend paid by each such security. The transactional tax information could also include, for example, the details of an aggregate interest amount including identifiers of securities that paid interest in the account and the specific amount(s) of interest paid by each such security. Further, in at least one embodiment, the tax information database can include several tax years of tax information. For example, in at least one embodiment, the tax information database includes tax information for at least 3 tax years to facilitate, among other things, reissuance of tax forms, adjustments of tax information data, and answering of questions regarding issued tax forms.

With the tax information in the tax information database, the tax reporting system 100, 540 may access the tax information through, for example, stored procedures executed against the tax information database. Further, the tax reporting system may have access to other databases that provide investment information. For example, the tax reporting system has access to a customers and accounts database 550 which provides information regarding a financial institution's customers and accounts and includes investment information such as the name and address of the customer that owns an account and other account information. The tax reporting system may further have access to an investment advisors database 560 which provides information regarding a financial institution's investment advisors and includes investment information such as investment advisor names and lists of accounts associated with a particular investment advisor. Also, the tax reporting system have access to a securities database 570 which provides information regarding securities (e.g., bonds, stocks, etc.) held in the financial institution's accounts and includes investment information such as securities symbols and tax classifications. In at least one embodiment, the tax information database, the customers and accounts database, the investment advisors database and the securities database are relational databases that are accessible in real-time using SQL or other queries.

The tax reporting system, as described herein more detail, takes the tax information and/or investment information to generate one or more screens comprising the tax and/or investment information which are transmitted to a client for viewing by a user 590. In at least one embodiment, the screens comprise tax and/or investment information that corresponds to particular tax forms, such as the IRS 1099, 1042S and 480.6A,B,C forms. Further, the tax reporting system may generate one or more reports and/or tax forms 580, which may or may not correspond to the screens provided to a client. For example, the tax reporting system may use the tax and/or investment information to generate tax forms, such as the IRS 1099, 1042S and 480.6A,B,C forms. Alternatively, the tax reporting system may provide the relevant tax and/or investment information to another system for generating one or more reports and/or tax forms, such as the IRS 1099, 1049S and 480.6A,B,C forms. In at least one embodiment, the tax reporting system may generate or instruct another system to generate a bar code on one or more tax forms. The bar code is used to designate one or more particular letter inserts to be provided with the tax form(s) and is read by a machine that packages the inserts with the tax form(s) before distribution to the customer (or other third party).

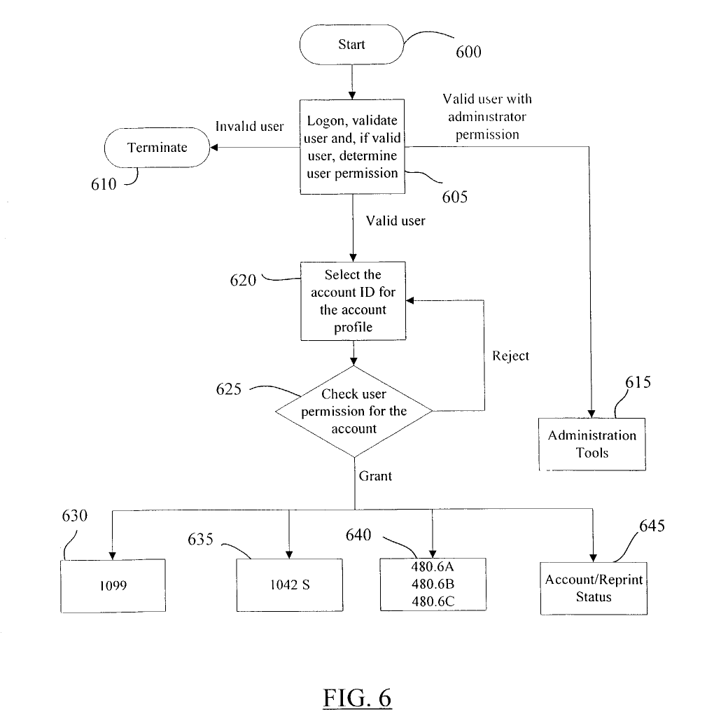

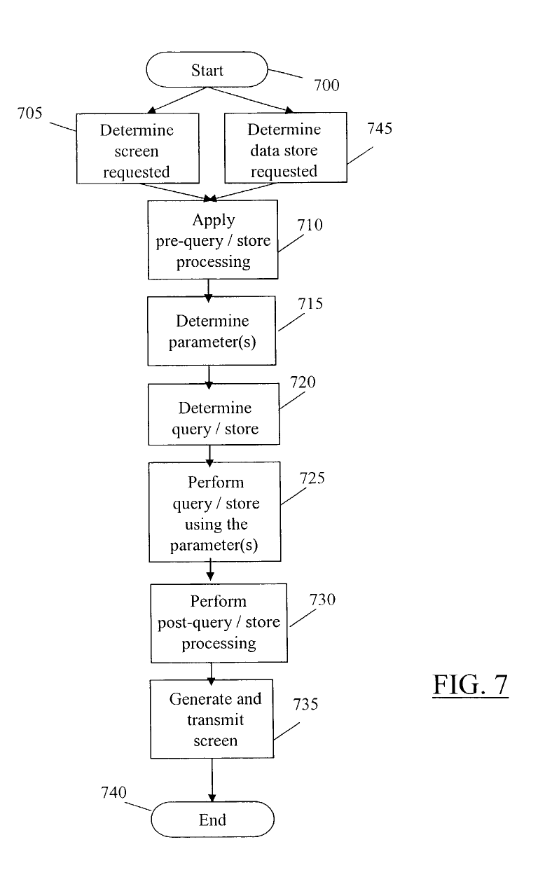

The tax reporting system described above may be configured to provide useful tax reporting functionality to one or more users, such as an investor or an investment advisor, for tracking and monitoring tax reporting information. FIGS. 6 and 7 illustrate an implementation of a method as may be provided by the tax reporting system to provide tax reporting functionality in accordance with the at least one embodiment of the present invention.

Although the method is disclosed in specific detail, its disclosure is intended to be illustrative of the features provided by at least one embodiment of the present invention, and are not to be construed as limitations. For example, the discussion below describes the operation of various components of the tax reporting system 100 with respect to particular types of investment information and tax information. Further, the tax reporting system 100 may provide tax reporting functionality for accounts at one or more various account providers in which an investor holds or trades securities such as stocks, bonds, mutual funds, commodities futures and related securities.

FIG. 6 illustrates an implementation of a tax reporting method in accordance with at least one embodiment of the invention. A tax reporting method may be initiated upon the tax reporting system receiving a login or entry request from a client at 605. To initiate a login or entry request, a user may enter the URL associated with a server into the address line of a browser application. Alternatively, a user may select an associated hyperlink contained on an interactive page using a pointing device such as a mouse or via keyboard commands. This causes an HTTP-formatted electronic message to be transmitted to the server (after Internet domain name translation to the proper IP address by an Internet proxy server) requesting a login/entry screen comprising one or more HTML or XML login/entry pages. In response, the server generates and transmits an interactive HTTP-formatted login/entry screen (e.g., “Welcome” page) to the client, and establishes a session. The login/entry screen may include data entry fields in which a user of the client may enter identification and/or authentication information such as the user's name and password assigned for use with the tax reporting system. To effect login, the user may cause the client to transmit the entered information to the server via, for example, a “Submit” button on the login/entry screen.

In response to receiving a login request from a client, the tax reporting system may validate the user of the client at 605 by comparing the user name and password information received in the login request to corresponding user data stored in or accessed by the tax reporting system. In at least one embodiment, the tax reporting system may perform a query against a user database that lists the authorized users of the tax reporting system and the permission level associated with the user (as described in more detail below). If the tax reporting system determines that the user login identification/authentication information is invalid, the tax reporting system may terminate login and prevent access to the tax reporting system at 610.

If the tax reporting system determines that the user login identification/authentication information is valid, the tax reporting server determines the user permission for the user identified in the login request at 605. In at least one embodiment, the tax reporting system may perform a query against a user database that lists the authorized users of the tax reporting system and the permission level associated with the user (as described in more detail below). If the user has administrator permission, the user may have access via the client to various administrative functions of the tax reporting system through an administrative tools screen at 615, as described in more detail below.

In at least one embodiment, at least four levels of permission are provided in the tax reporting system and which may be assigned to users of the tax reporting system. The permission level of a user may be adjusted through the administrative tools function of the tax reporting system. Other permission levels may be provided for particular accounts, groups of users, etc.

A first permission level corresponds to a tax reporting manager of a financial institution. The first permission level permits such a user to perform all functions of the tax reporting system including viewing all screens, request tax form printing, adjusting tax classifications of securities and global requests (discussed in more detail hereafter), and administrative tools functions. A second permission level corresponds to other tax reporting personnel in a financial institution. The second permission level permits such a user to view all forms, request tax form printing, and perform administrative tools functions. The third permission level corresponds to a financial advisor manager of a financial institution. The third permission level permits such a user to view screens and request printing of tax forms for accounts within that manager's responsibilities. The fourth permission level corresponds to financial advisors of a financial institution. The fourth permission level permits such a user to view screens and request printing of tax forms for accounts that financial advisor manages. The first and second permission levels correspond to administrator permission.

If the user is valid (whether with or without administrator permission), the tax reporting system generates and transmits an account profile screen to the client at 620. In the tax reporting system, all tax and investment information is associated with an account of an individual or entity and is accessed using account identification information. As will be apparent to those skilled in the art, tax and investment information may accessed using a key other than account identification number. For example, tax and investment information may accessed using an individual or entity name or identifier.

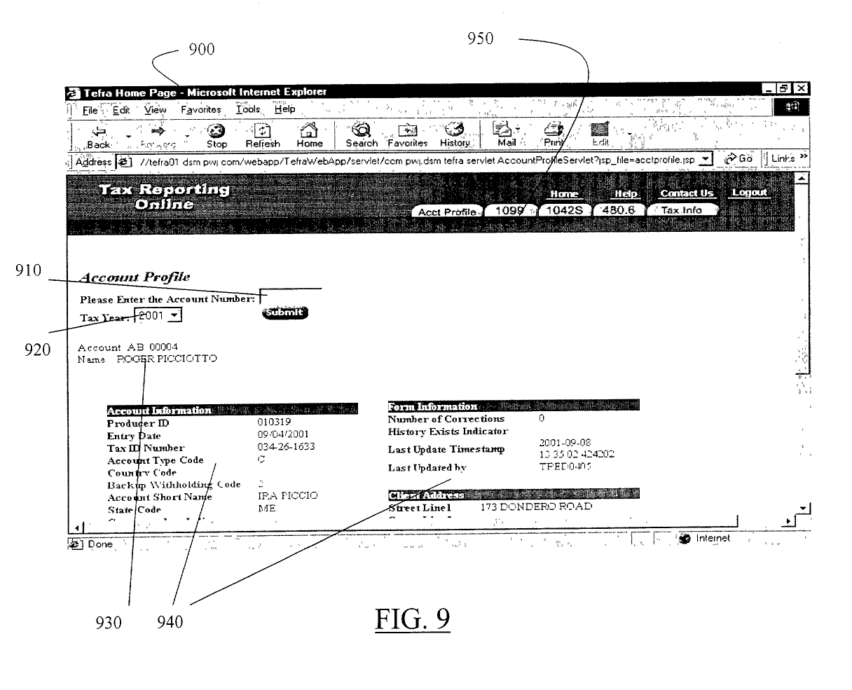

FIG. 9 illustrates an implementation of an account profile screen 900 in accordance with at least one embodiment of the invention. As shown in FIG. 9, the account profile screen 900, 840 includes a data field 910 for supplying account identification information, such as an account number, and a drop down field 920 for designating the tax year for which information is desired. When the account profile screen is first provided upon login, the account identification information 930 and the account information 940 (together the account profile) are not provided since no account has been specified. Optionally, specific account identification information may be associated by default with a user's login and so an account profile may be provided upon login.

Once the account profile screen is presented to the user on the client, the user can enter account identification information, such as an account number, into the data field to obtain the account profile in the tax reporting system for that account at 620. If invalid account identification information is detected, a message is returned back to the user prompting the entry of valid account identification information. As will be apparent to those skilled in art, error handling, such as just described, may be applied to all aspects of the tax reporting system, including other screens and the actual operation of the hardware and software of the tax reporting system.

If the user has permission for access to the account associated with the entered account identification information at 625, the account profile is presented to the user by transmitting an updated account profile screen to the client including the account profile. The account profile is generated using database queries as discussed below in reference to FIG. 7. If the user has no permission for access to the account associated with the entered account identification information, an updated account profile screen is transmitted to the client that indicates denial of access or simply clears the data field for entry of new account identification information. In at least one embodiment, once an account has been selected, all other interactions within the tax reporting system are performed relative to the selected account. To change to another account, the user would return to the account profile screen to enter and submit new account identification information (and thereafter all further interactions with the tax reporting are performed relative to the new account).

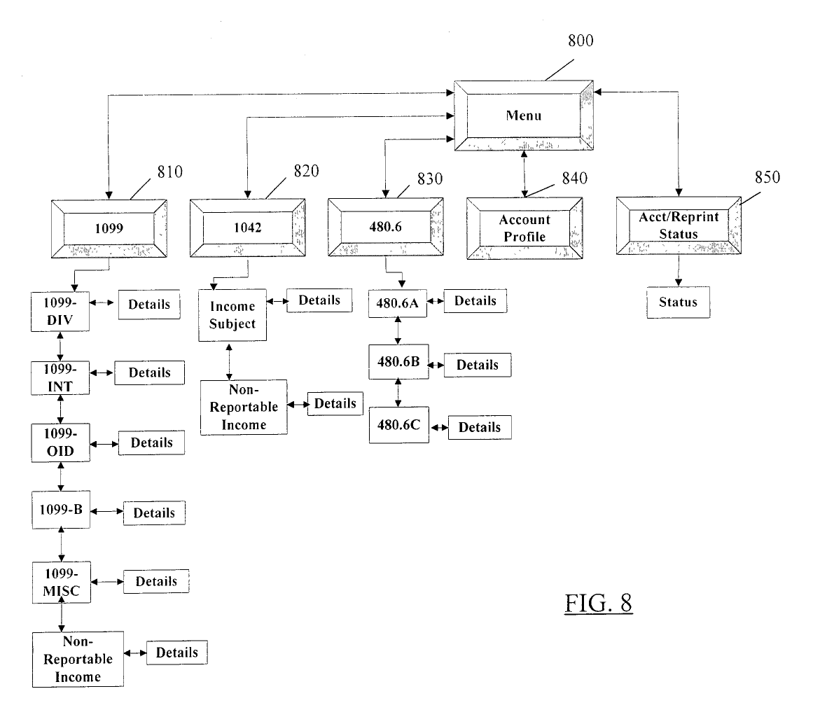

If the user has permission to access the account, the user may access through the client at 630, 635, 640, 645 one or more other screens for the selected account. Further, the user may access such screens for the account based upon a particular tax year by using the drop down box to select the desired tax year in the account profile screen before accessing such screen for the account. In at least one embodiment, once a tax year has been selected, all other interactions within the tax reporting system are performed relative to that selected tax year. To change to another tax year, the user would return to the account profile screen to select a new tax year (and thereafter all further interactions with the tax reporting are performed relative to the new selected tax year). Referring to FIGS. 7 and 8, the other screens can include a 1099 (including non-reportable income) tax form screen 630, 810, a 1042S tax form screen 635, 820, a 480.6 tax form screen 640, 830, and an account/reprint status screen 645, 850. The user may also access through the client the administrative tools screen 615. More details about these screens and their generation and transmission are provided below.

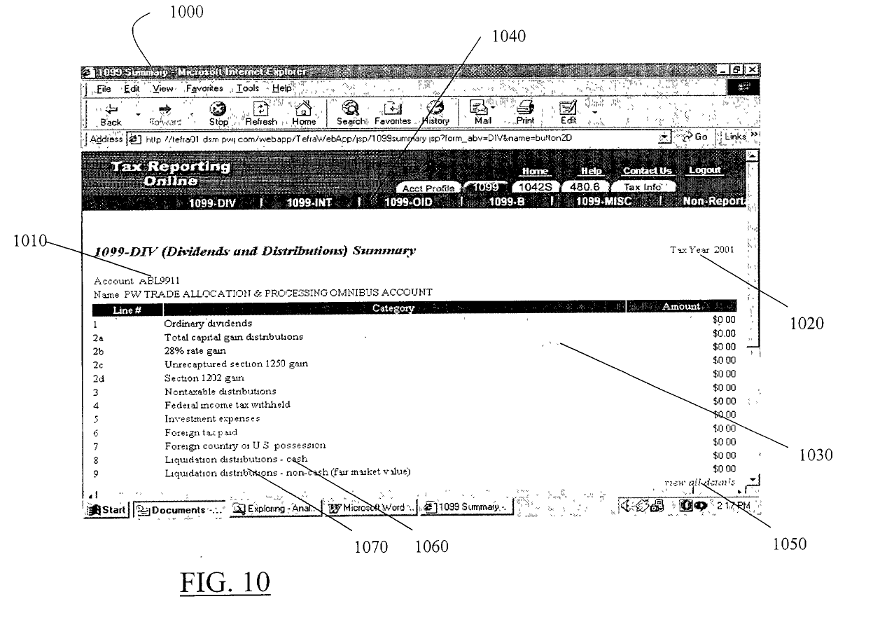

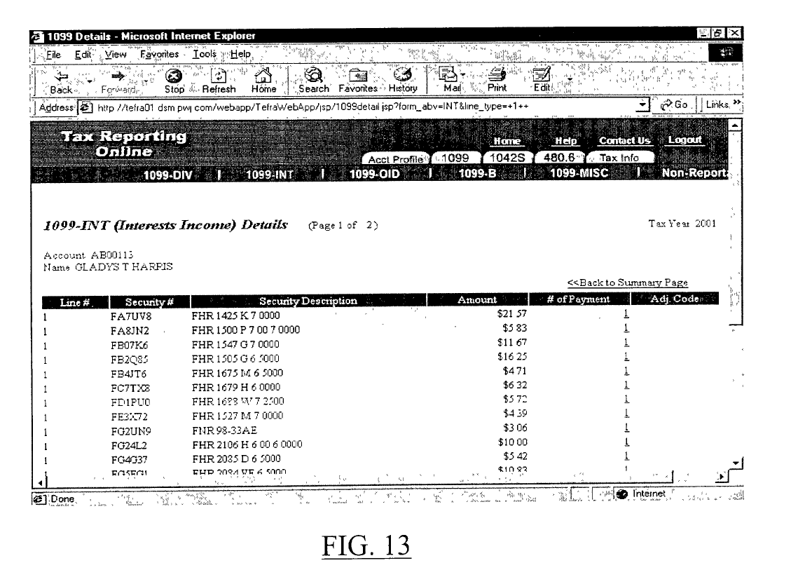

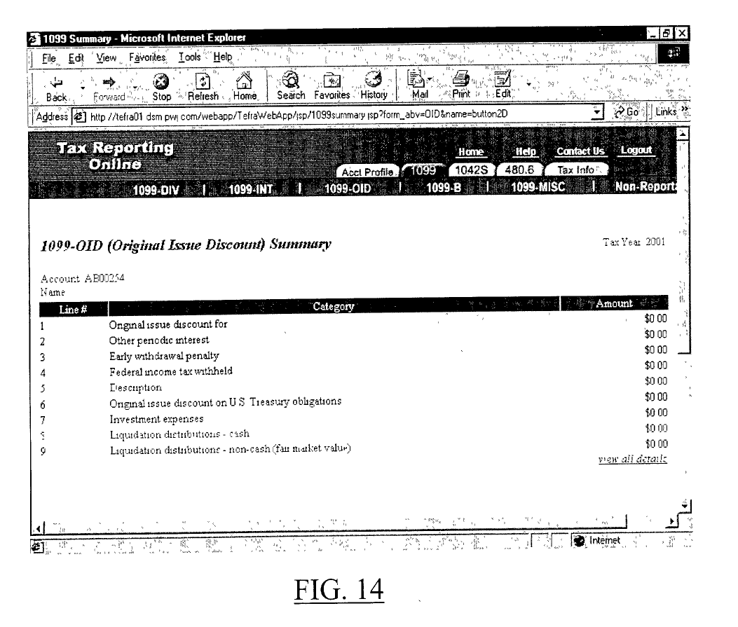

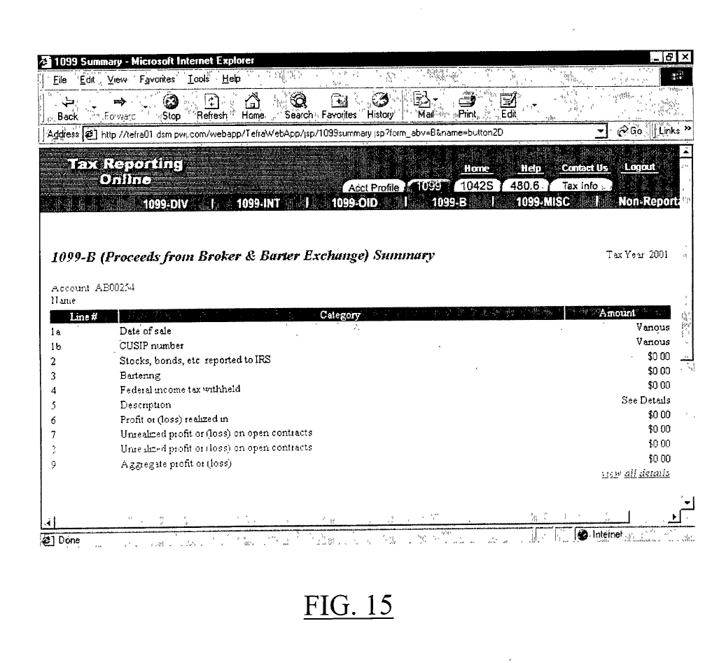

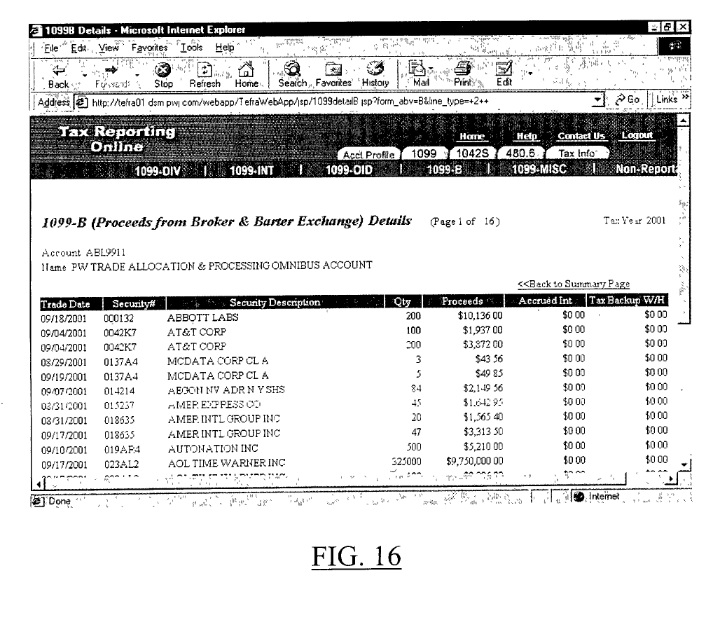

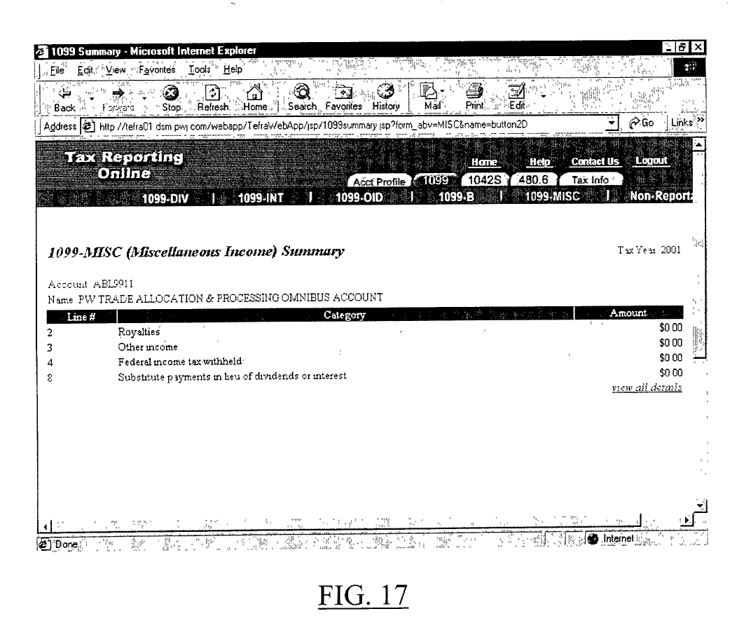

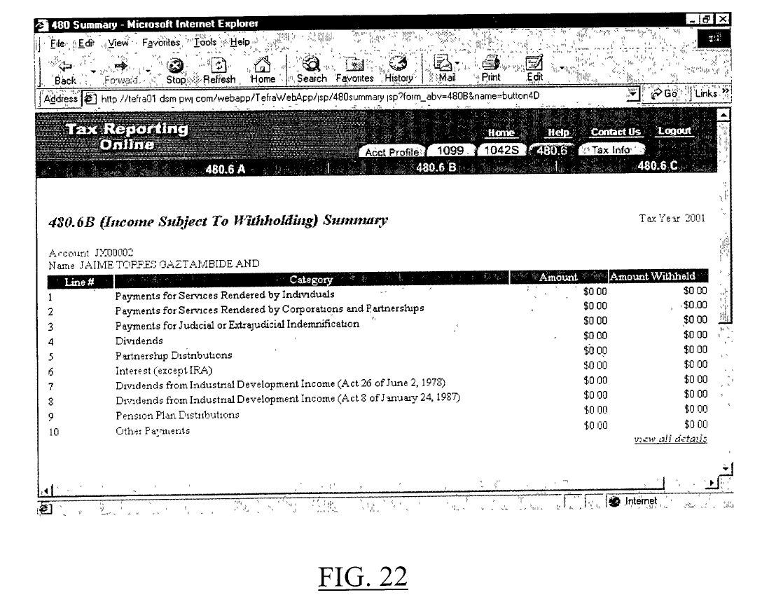

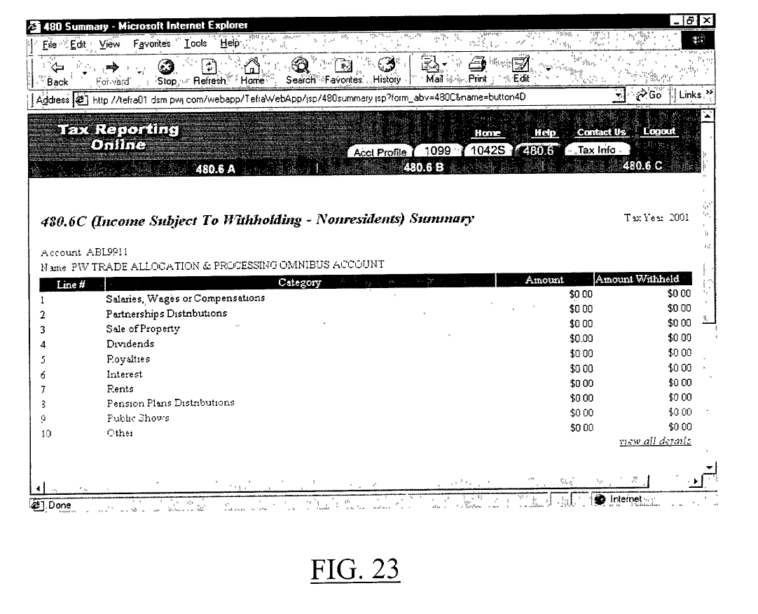

Referring to FIG. 9, the account profile screen includes one or more interactive user tabs 950 by which the user may access other screens for the account. To access a particular screen for the account, the user may select the corresponding tab in the account profile screen. Upon user selection of a tab, a hyperlink may be activated in which an HTTP-formatted request for one or more interactive HTML or XML pages corresponding to the selected screen for the account is transmitted to the tax reporting system. So, for example, user selection of the “1099” tab in FIG. 9 would cause the activation of a request for the one or more 1099 tax form screens of the tax reporting system. Referring to FIGS. 10-23, the same interactive user tabs of FIG. 9 are provided for the screens depicted. Accordingly, in any of those screens, the user can navigate to other screens by selecting an interactive tab, including returning back to the account profile screen.

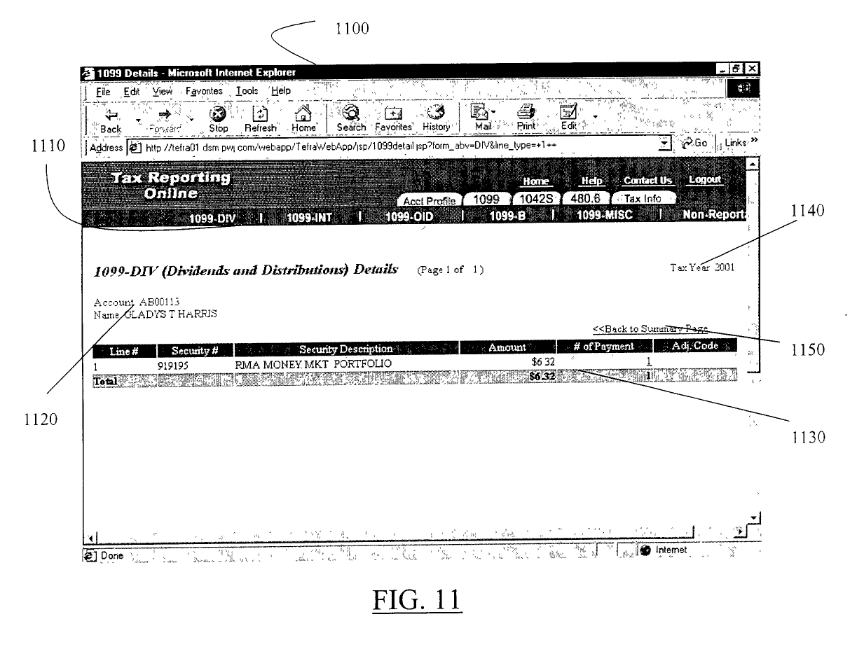

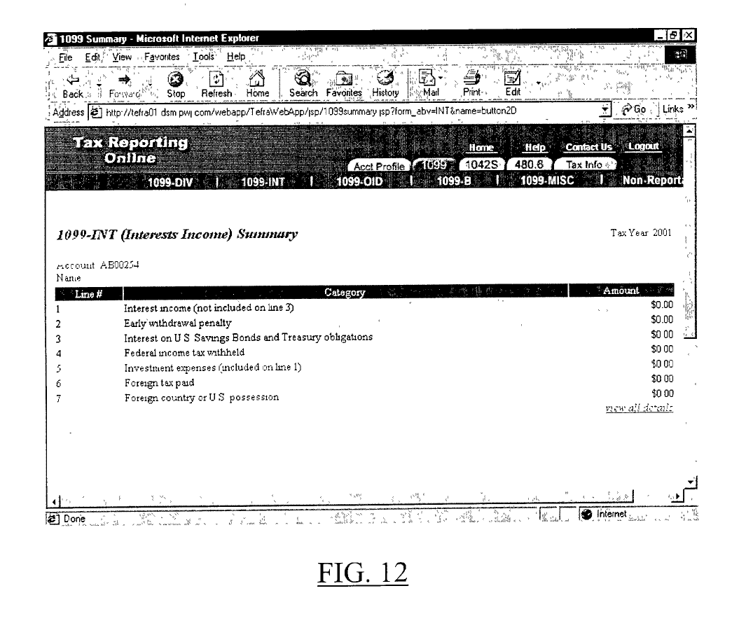

Further, referring to FIGS. 10 and 11, the 1099 tax form screen includes one or more interactive user sub-tabs 1040, 1110 by which the user may access other types of the screen for the account. To access a particular type of the 1099 tax form screen for the account, the user may select the corresponding sub-tab in the 1099 tax form screen. Upon user selection of a sub-tab, a hyperlink may be activated in which an HTTP-formatted request for one or more interactive HTML or XML pages corresponding to the selected type of the screen for the account is transmitted to the tax reporting system. So, for example, user selection of the “1099-INT” sub-tab in FIGS. 10 and 11 would cause the activation of a request for the 1099-INT tax form screen of the tax reporting system. Referring to FIGS. 12-23, the same interactive user sub-tabs of FIGS. 10 and 11 are provided for the screens depicted. Accordingly, in any of those screens, the user can navigate to other types of that screen by selecting an interactive sub-tab.

In at least one embodiment, on first login, the account profile screen does not include the one or more interactive user tabs unless specific account identification information is associated by default with a user's login (and so an account profile is provided upon login). However, where specific account identification information has been provided and submitted by a user in the account profile screen, the account profile screen refreshes with the one or more interactive tabs. In another embodiment where no specific account identification information is associated by default with a user's login, the one or more interactive tabs in the account profile screen may be provided but cannot be used until specific account identification information has been provided and submitted by a user in the account profile screen.

In response to a selection of a particular screen for the account by, for example, receiving a hyperlinked request, the tax reporting system may generate and transmit to the user's client the requested screen, comprising one or more interactive HTML or XML pages with, for example, selected tax and/or investment information of the account for the selected tax year. To generate the HTML or XML page(s) of the screen, the tax reporting system causes various operations to be performed as generally described above and described in more detail below.

Referring to FIG. 7, the tax reporting system software determines the particular screen chosen from the request at 705. For example, where the request was a hyperlinked request from an interactive tab, the HTTP message sent to the tax reporting system is processed to determine the particular screen requested and where multiple types of the requested screen are available, a default type of that screen is provided as the requested screen. So, for example, in the case of the choice of the “1099” interactive tab in FIG. 9, the tax reporting system would determine that a 1099 tax form screen is requested and in this case because there are multiples types of 1099 tax form screen, the default type of 1099 tax form screen—1099-DIV—would be provided as the requested screen.

The tax reporting system software may then apply certain pre-query processing based on information in the tax reporting system or obtained from other sources at 710. For example, in at least one embodiment, the tax reporting system software may use user identification/authentication information and/or user permission information to determine whether the requested screen may be accessed by the user.

Based on the particular screen requested, the tax reporting system determines the parameters needed to retrieve the relevant tax and/or investment information for the requested screen at 715. In at least one embodiment, the tax reporting system software retrieves the account identification information (provided as default for a user or entered by a user in the account profile screen) and the tax year (whether the default tax year or the year specifically entered by the user in the account profile screen) and uses them as parameters for execution of a stored procedure against the tax information database. Where the particular screen requires other information, such as investment information, the tax reporting system software may generate one or more parameters for use in one or more stored procedures executed against one or more investment information databases.

The tax reporting system software then determines the one or more queries needed to generate the requested screen at 720. In at least one embodiment, for example, each of the screens has one or more stored procedures associated therewith to extract the tax and/or investment information needed for the screen. Further, different stored procedures are provided to obtain the tax and/or investment for the summary and details views of a screen, as discussed in more detail below.

The tax reporting system software then performs the query(ies) using the parameter(s) to obtain the tax and/or investment information needed for the requested screen at 725. In at least one embodiment, the tax reporting system software calls the stored procedure(s) associated with the requested screen and with the relevant database(s) using the parameter(s) to extract the tax and/or investment information needed for the requested screen. The stored procedure(s) queries the tables of the tax and/or investment information databases for the tax and/or investment information needed to generate the requested screen and returns the requested tax and/or investment information and other results, if any, to the tax reporting software.

Where the requested screen requires further post-query processing of the returned tax and/or investment information or other results, if any, the tax reporting software may perform a series of operations using such information and results at 730. In at least one embodiment, for example, the tax reporting software may perform a summation of returned tax information for presentation on the requested screen. Further, the tax reporting software may terminate the presentation of the requested screen where there is no tax and/or investment information returned for the requested screen. Also, the tax reporting software may terminate the presentation of the requested screen and return an error message where no tax and/or investment information is returned or where the returned tax and/or investment information is corrupt or incorrect.

After receipt and processing, if any, of the returned tax and/or investment information and other results, if any, the tax reporting software generates and transmits the requested screen incorporating the returned tax and/or investment information at 735. In at least one embodiment, the tax reporting software facilitates display of all or some of the returned tax and/or investment information and other results, if any, by generating and transmitting one or more interactive HTML or XML pages to the client via the client communications interface. In particular, the interactive HTML or XML page(s) may be generated including and/or using the requested tax information and/or investment information and transmitted to the requesting client in accordance with HTML and JSP formatting. Alternatively, the page(s) may be generated and transmitted in accordance with the ASP standard developed by Microsoft Corporation.

In certain screens, such as the administrative tools and edit screens, a user would be able to store information into one or more databases, such as the tax information database and/or the investment information database. So, referring to FIG. 7, the tax reporting system software determines whether an information store operation has been requested at 745. For example, where the request was a hyperlinked request from a submit button, the HTTP message sent to the tax reporting system is processed to determine the particular store operation requested. Along with the request, the information to be stored may be provided. The tax reporting system software may then apply certain pre-store processing based on information in the tax reporting system or obtained from other sources at 710. For example, in at least one embodiment, the tax reporting system software may use user identification/authentication information and/or user permission information to determine whether the requested store operation may be performed by the user. The tax reporting system software may also apply certain pre-store processing based on the information submitted along with the store operation request. For example, in at least one embodiment, the tax reporting system software may perform checking on the submitted information, such as error checking or checking to determine the information has been submitted in a proper form. In at least one embodiment, the tax reporting system software may modify the submitted information to conform to a format of the tax and/or investment information database.

Based on the particular store operation requested, the tax reporting system determines the parameters needed to store the submitted information at 715. In at least one embodiment, the tax reporting system software retrieves the account identification information (provided as default for a user or entered by a user in the account profile screen) and the tax year (whether the default tax year or the year specifically entered by the user in the account profile screen) and uses them as parameters for execution of a stored procedure against the tax information database and/or investment information database.

The tax reporting system software then determines the one or more store operations needed to store the submitted information at 720. In at least one embodiment, for example, one or more stored procedures associated with the tax and/or investment information databases and the particular screens are provided for performing the store operations of the functions of the screens.

The tax reporting system software then performs the store operations using the parameter(s) to store at 725 the submitted information, as modified. In at least one embodiment, the tax reporting system software calls the stored procedure(s) associated with the requested screen and with the relevant database(s) using the parameter(s) to store the submitted information, as modified. The stored procedure(s) accesses the tables of the tax and/or investment information databases to store submitted information, as modified, and returns a confirm or error message, as the case may be, to the tax reporting software.

Where the store operation requires further post-store processing based upon the returned message, the tax reporting software may perform a series of operations using the message at 730. In at least one embodiment, if an error message is returned, the tax reporting software may cause an error notice to be returned to the user when the screen is updated.

After receipt of the error or confirm message, the tax reporting software generates and transmits an updated screen reflecting the completion of the store operation or indicating an error notice at 735. In at least one embodiment, the tax reporting software facilitates display of the updated screen in accordance with the operations of FIG. 7 for a screen request and including, where applicable, an error notice or stop operation confirmation.

Furthermore, a user may also choose to request a different view of a particular screen displayed on the client. In at least one embodiment, the tax reporting system may provide a details view in addition to the summary view typically provided by default in the tax reporting system. To request a details view, the user may select, for example referring to FIG. 10, a “view all details” hyperlink 1050 on the summary view of the screen. In response to receiving such a request for a details view, the tax reporting system may generate and transmit the associated one or more interactive HTML or XML page(s) of the screen formatted for the details view to the client. So, referring to FIG. 7, the tax reporting system may perform the same or similar operations associated with a request for a screen. In particular, in response to receiving such a request for a details view, the tax reporting system may obtain additional items of tax and/or investment information required to generate the details view of the screen by causing the execution of one or more stored procedure(s) against the relevant database(s). In response, the stored procedure(s) may obtain the requested additional items of tax and/or investment information and provide that information to the tax reporting system for subsequent generation and transmission of one or more details view HTML or XML pages to the client. In at least one embodiment, there are separate stored procedures to obtain the information for the summary view of the screens (e.g., FIGS. 10, 12, 14, 15 and 17-23) and other stored procedures to obtain the information for the details view of the screens (e.g., FIGS. 11, 13 and 16). In at least one embodiment, a user can return to the summary view of the screen by, for example referring to FIG. 11, clicking on a “Back to Summary Page” link 1150, which causes regeneration and transmission of the summary view of the screen.

In at least one embodiment, the summary view of a tax form screen comprises aggregate tax information pertaining to the tax form of the screen. Further, the additional items of tax information comprise transactional tax information and the details view of a tax form screen comprises selected transactional tax information regarding the aggregate tax information shown in the summary view of the tax form screen. Such a details view of a tax form screen provides a user with detailed tax information regarding an account and enhances, among other things, reconciliation, resolution, and explanation of questions pertaining IRS form items. So, for example, referring to FIG. 10, the summary view of the 1099-DIV tax form screen 1000 shows, for the 2001 tax year 1020, aggregate tax information 1030 for the 1099-DIV tax form of account “ABL9911” 1010 including the amount of ordinary dividends paid on securities in that account, the total capital gain distribution distributed on securities in that account, etc. Referring to FIG. 11, the details view of the 1099-DIV tax form screen 1100 shows, for the 2001 tax year 1140, transactional tax information 1130 for the 1099-DIV tax form of account “AB00113” 1120 including the security number, the security description and the dividend or other distribution amount associated with that security.

From time to time the user may choose to refresh the information contained in one or more interactive HTML or XML pages displayed on the client by selecting the “Refresh” browser button. In response to receiving a request to refresh the displayed information, the above-described methods are reapplied to obtain updated information for the particular HTML or XML page(s) displayed at the client at the time of the refresh request.

FIG. 8 depicts a hierarchical layout of the menu structure of the screens of at least one embodiment of the present invention. Referring to FIGS. 10-23, a number of the IRS tax form screens (referenced in FIG. 8) according to at least one embodiment of the invention are depicted. Each of the screens comprises various tax and/or investment information pertaining to a particular account for a particular tax year. In accordance with at least one embodiment, the tax and/or investment information is presented in row and column format as shown in FIGS. 10-23 with certain of the columns being summed and listed using a total value as shown in FIG. 11.

As can be seen in the screen of FIGS. 10-23, the tax reporting system provides a user-friendly and intuitive environment for viewing and updating tax and/or investment information. Fields and screens are descriptively labeled and point and click navigation can be utilized for a user to access additional screens or view of screens. Further, the screens offer the user a link to one or more help screens, such help screen(s) providing the user general guidance on the tax reporting system and/or particular screens. The screens also offer the user a link to one or more contact screens, such contact screen(s) providing the user the ability to request specific guidance or to make other comments. As will be apparent to those skilled in the art, the contact and help links could call other applications such as an e-mail application or a help application respectively to provide their respective services.

Referring to FIGS. 10 to 18, various IRS 1099 tax form and non-reportable income tax screens according to at least one embodiment of the invention are depicted. The 1099 DIV tax form screen provides information corresponding to the IRS 1099 dividend tax information reporting form for the account. The 1099 INT tax form screen provides information corresponding to the IRS 1099 interest tax information reporting form for the account. The 1099 OID tax form screen provides information corresponding to the IRS 1099 original issue discount tax information reporting form for the account. Original issue discount is the difference between the stated redemption price at maturity and the issue or purchase price of a bond, debenture, note or other evidence of indebtedness, or the acquisition price of a stripped bond or coupon. The 1099 B tax form screen provides information corresponding to the IRS 1099 gross proceeds tax information reporting form for the account. The 1099 MISC tax form screen provides information corresponding to the IRS 1099 miscellaneous tax information reporting form for the account. The Non-Reportable Income screen provides information corresponding to the non-reportable income tax information for the account. Each of these 1099 tax form and non-reportable income screens is provided in summary view by default although a details view of the screen can be accessed through, for example, the selecting of the “view all details” hyperlink seen in FIGS. 10, 12, 14, 15, 17 and 18. A summary view of each of the 1099 tax form and non-reportable income screens can be accessed from the details view of the screen through, for example, the selecting of the “Back to Summary Page” hyperlink seen in FIGS. 11, 13, and 16.

In at least one embodiment, the 1099-DIV tax form screen provides tax information regarding taxable exchanges of securities. Referring to FIG. 10, the cash proceeds of a taxable exchange of one or more securities in the account are shown as liquidation distributions—cash 1060. Further, the fair market value of the one or more securities after the taxable exchange are shown as liquidation distributions—non-cash (fair market value) 1070. The tax reporting system calculates the fair market value based upon the tax information in the tax information database. In at least one embodiment, when the 1099-DIV form is printed, the fair market value of the one or more securities after a taxable change are printed in optional portion of the 1099-DIV form while the cash received from the taxable exchange are shown as proceeds. In an embodiment, the fair market value of each of the securities after a taxable exchange is shown.

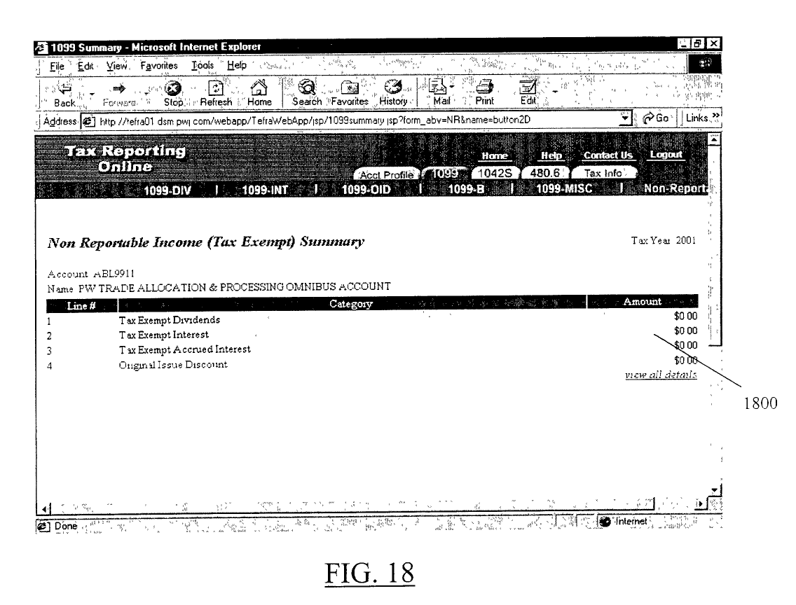

In at least one embodiment, the Non-Reportable Income screen provides tax information regarding tax exempt distributions from securities. Referring to FIG. 18, the tax exempt dividends and interest of one or more securities in the account are shown as tax exempt dividends, tax exempt interest, and/or tax exempt accrued interest 1800. In at least one embodiment, when the Non-Reportable Income form is printed, the tax exempt distributions are grouped by state and printed, preferably, in alphabetical order by state, on a Non-Reportable Income form. So, for example, the tax exempt interest from Calif. municipal bonds would be grouped together and followed by the tax exempt interest from New York municipal bonds.

In at least one embodiment, where the customer of an account changes tax status in a tax year, the tax reporting system divides the taxable income of the customer among the respective applicable tax form screens depending on the tax status of the customer. So, as an example, for a customer that changes from non-resident to resident during the tax year, the tax reporting system shows the portion of income while the customer was nonresident on the 1042S tax form screen(s) (and printed on the 1042 tax form(s)) and shows the other portion of the income while the customer was resident on the 1099 tax form screen(s) (and printed on the 1099 tax form(s)). To divide the taxable income, the tax reporting system would perform the appropriate tax information retrieval and calculations based upon the change of tax status date of the customer.

In at least one embodiment, the 1099-B tax form screen provides the cost basis and realized gain/(loss) of securities in the account. And, when the 1099-B tax form is printed, the cost basis and/or realized gain/(loss) of the securities in the account is printed on the form. In at least one embodiment, when the 1099-B tax form is printed, the cost basis and/or the realized gain/(loss) of each of the securities in the account is shown on the 1099-B tax form.

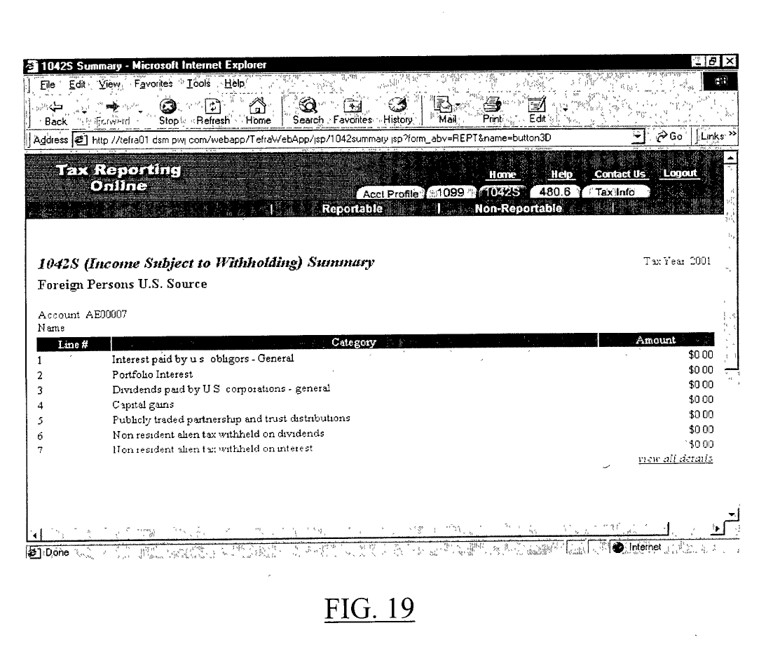

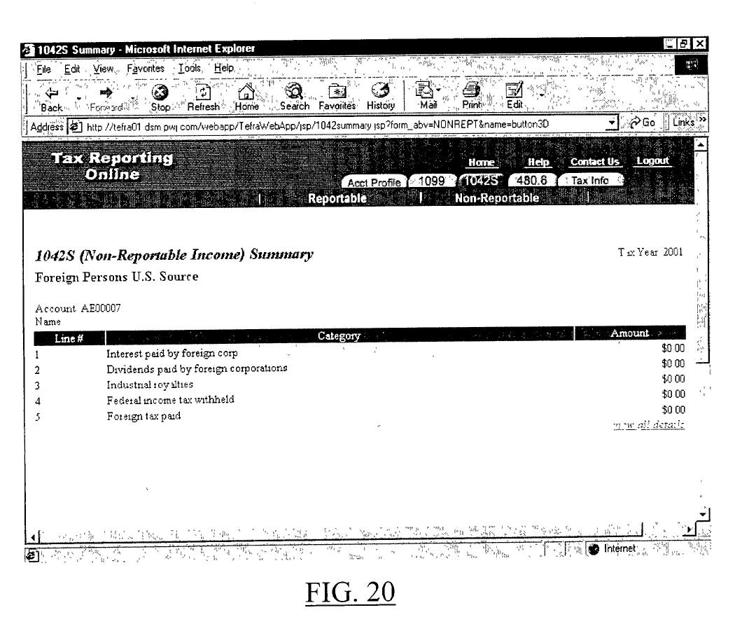

Referring to FIGS. 19 and 20, IRS 1042S tax form screens according to at least one embodiment of the invention are depicted. The 1042 S (Foreign Persons U.S. Source Income Subject to Withholding) tax form screen provides information corresponding to the IRS 1042S foreign persons' accounts' U.S. source income subject to withholding tax information reporting form for the account. The 1042 S (Foreign Persons U.S. Source Non-Reportable Income) tax form screen provides information corresponding to the IRS 1042S foreign persons' accounts' U.S. source non-reportable income subject to withholding tax information reporting form for the account. Each of these 1042 S tax form screens is provided in summary view by default although a details view of the screen can be accessed through, for example, the selecting of the “view all details” hyperlink seen in FIGS. 19 and 20. A summary view of each of the 1042S tax form screens can be accessed from the details view of the screen through, for example, the selecting of a “Back to Summary Page” hyperlink (not shown).

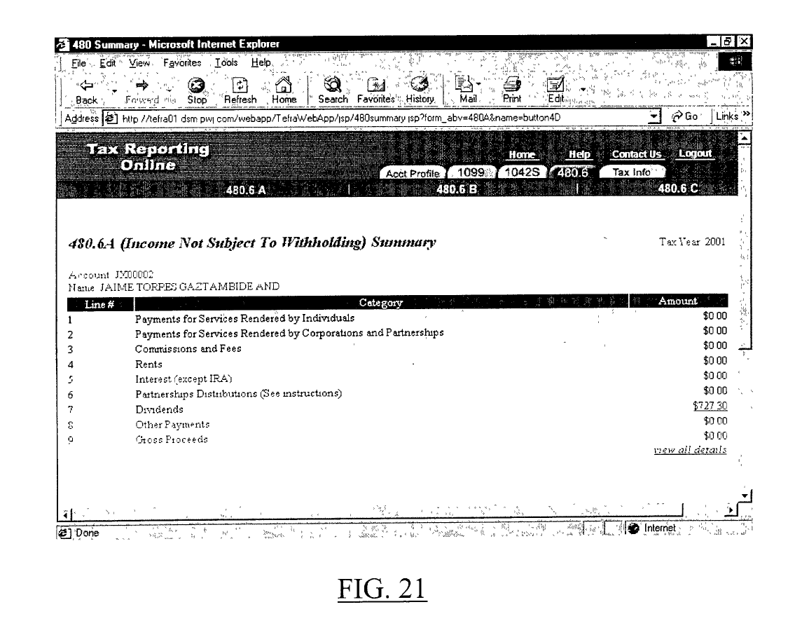

Referring to FIGS. 21 and 20, IRS 480.6 tax form screens according to at least one embodiment of the invention are depicted. The 480.6A (Income Not Subject to Withholding) tax form screen provides information corresponding to the IRS 480.6A Puerto Rico accounts' U.S. source income not subject to withholding tax information reporting form for the account. The 480.6B (Income Subject to Withholding) tax form screen provides information corresponding to the IRS 480.6A Puerto Rico accounts' U.S. source income subject to withholding tax information reporting form for the account. The 480.6C (Income Subject to Withholding) tax form screen provides information corresponding to the IRS 480.6A Puerto Rico accounts' U.S. source income subject to withholding non-residents tax information reporting form for the account. Each of these 480.6 tax form screens is provided in summary view by default although a details view of the screen can be accessed through, for example, the selecting of the “view all details” hyperlink seen in FIGS. 21, 22 and 23. A summary view of each of the 480.6 tax form screens can be accessed from the details view of the screen through, for example, the selecting of a “Back to Summary Page” hyperlink (not shown).

Referring to FIG. 8, the tax reporting system in accordance with at least one embodiment of the invention may provide an account/reprint status screen 860. Through this screen, a user can request the re-issuance of a particular tax form and view the status of the printing of the tax form. A user may also get data regarding the status of the accounts such as whether it is active, inactive, closed, etc.

In accordance with at least one embodiment of the invention, the tax reporting system may provide one or more administrative tools screens through which the user can perform certain administrative tool functions, including viewing and updating certain tax information and/or investment information. In such a configuration, the tax reporting system may provide one or more interactive HTML or XML pages, like that of the screens described above, containing data entry fields in which a user may enter updated tax and/or investment information through the client. Upon receiving the updated tax and/or investment information from the client, the tax reporting system may use the received tax and/or investment information to populate corresponding records in the tax information and/or investment information databases. The administrative tools capability of the tax reporting system may comprise an audit trail or history feature to track all changes made. In at least one embodiment, the information changed, the user that made the change, and the date and time of the change are recorded.

In at least one embodiment, an administrative tools screen provides a user the ability to perform global updates and reclassifications of transactions and securities. For example, a financial institution's tax reporting personnel may, through the administrative tools screen, reclassify tax classifications of one or more transactions and/or securities from a default classification for the particular transaction or security to another classification. In at least one embodiment, to effect reclassification, a user modifies through the administrative tools screen a reclassification table in the tax reporting system. The reclassification table identifies the particular transaction or security to be reclassified and identifies the tax classification to be applied to that particular transaction or security. So, for example, the reclassification table could identify a particular derivative and identify that distributions from that derivative should receive dividend treatment. The reclassification table is then applied by the tax reporting system to the tax information in the tax information database to override a default classification applied to the particular security or transaction. In this manner, the user has the ability to reclassify payments to other forms of payment thus affecting their reportability to tax forms.

Similarly, a financial institution's tax reporting personnel may, through the administrative tools screen, update or correct information regarding one or more securities and have the corrections applied to all accounts. Once a particular change is made in the administrative tools screen, the user can submit the change and the relevant tax information in the tax information database is updated by the tax reporting system, as described above. Further, the administrative tools screen may provide the ability to determine how many corrections an account population has received before an adjustment is processed.

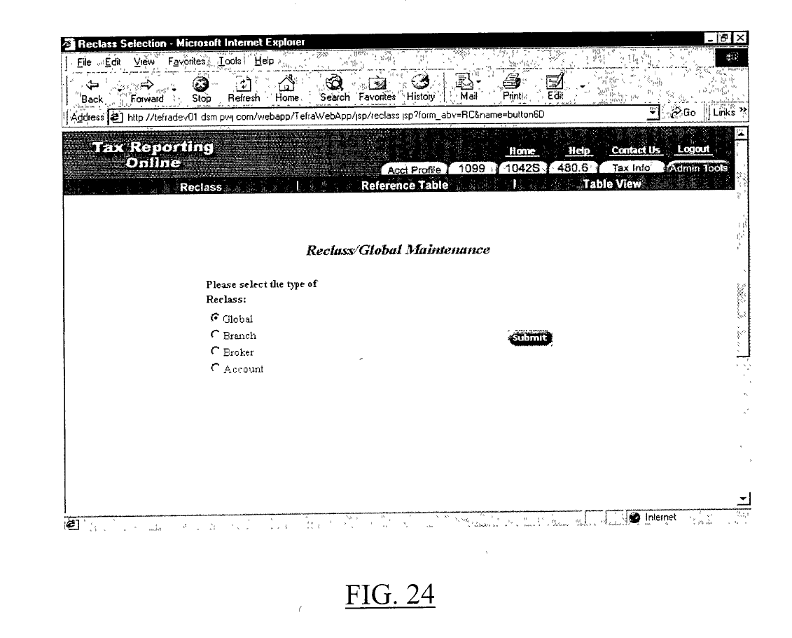

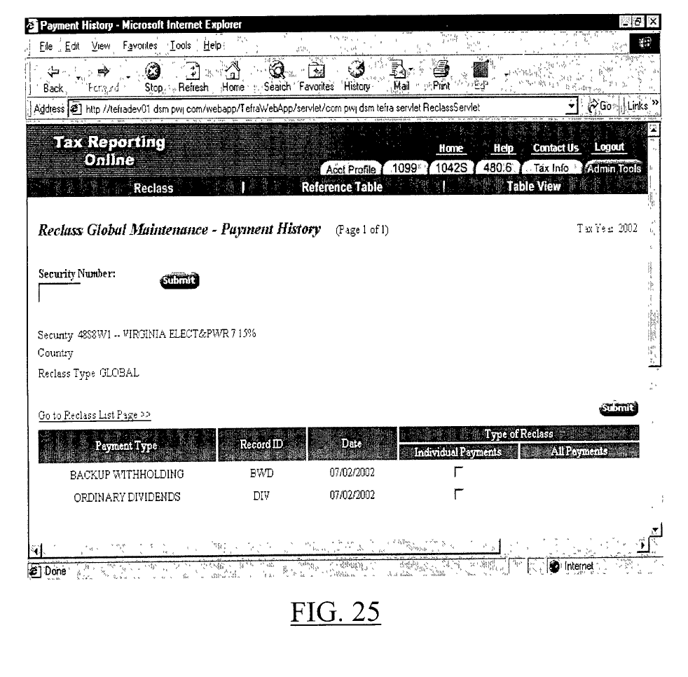

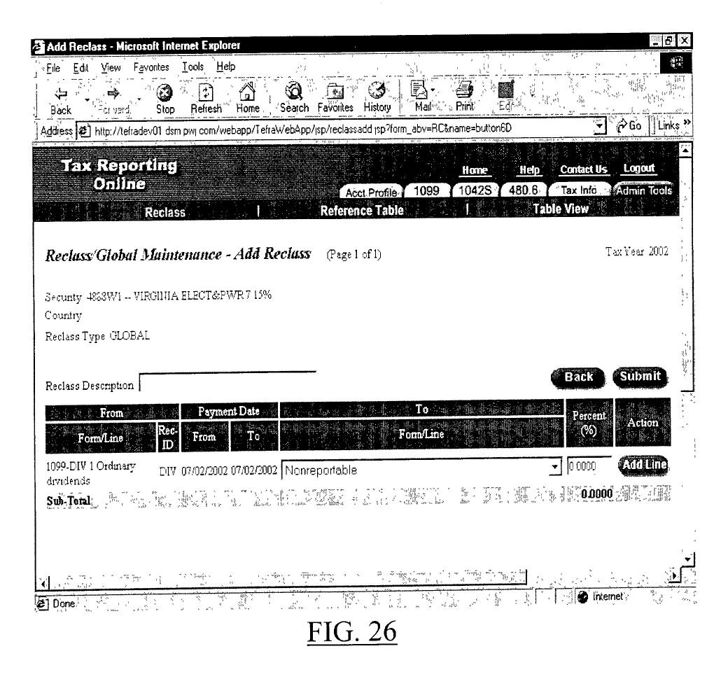

Referring to FIG. 24, a Reclass/Global Maintenance Type of Reclass screen is depicted. Through this screen, the user has the ability to make global changes on a security, account, broker and branch level by selecting the relevant radio button. Referring to FIGS. 25 and 26, a Reclass/Global Maintenance Payment History screen and a Reclass/Global Maintenance Add Reclass screen are depicted. Through the Payment History screen, the user can select a security to be reclassed by entering a security number in the “Security Number” field. Once a security is selected, the user can select on the Payment History screen the type of payment to be reclassed for that security. Once the payment type is selected and submitted by clicking the “Submit” button, the user can select on the Add Reclass screen the parameters of the reclass, such as whether the payment type should be non-reportable and if so, indicate the percentage of that payment type that should be non-reportable. By clicking the “Add Line” button, the user can apply different reclass parameters to the same payment type and indicate the percentage of the payment type to which the reclass parameters should apply. Once all the reclass information is provided, the user can submit the reclass information to the tax reporting system, by clicking the “Submit” button, so that the tax information is updated in accordance with the reclass information. The reclass information may include the security to be reclassed, the payment type of the security to be reclassed, the reclass parameters for a particular payment type of the security and whether the global change is on a security, account, broker and branch level.

For both global updates and reclassifications, the tax reporting system provides the ability to send a notice to one or more investment advisors of the financial institution regarding a global update and reclassification. So, for example, where a security's tax treatment is reclassified or information about a particular security or transaction is updated, a notice may be sent to the investment advisors that have accounts affected by the global update or reclassification to warn that investment advisor of the global update or reclassification. In at least one embodiment, the tax reporting system notifies another application that warns one or more investment advisors of the global update or reclassification, that indicates that one or more of the investment advisor's customers will receive an appropriate re-issued tax form, and that identifies the investment advisor's customers affected by the global update or reclassification. For example, the tax reporting system may call an e-mail application to send one or more e-mails to one or more investment advisors with a text body that warns of the global update or reclassification, that indicates that one or more of the investment advisor's customers will receive an appropriate re-issued tax form, and that identifies the investment advisor's customers affected by the global update or reclassification.

In at least one embodiment, the administrative tools screen may also provide a user with an option to designate one or more third parties (i.e., one or more individuals or entities other than the customer taxpayer) to which a particular tax form or another copy of the particular tax form may be distributed. For example, a user may designate that a copy of the printed 1099 form is sent directly to a customer's accountant. In at least one embodiment, the administrative tools screen permits a user to add or otherwise designate the name(s) and/or address(es) of a third party(ies) to which a copy of the 1099 form is to be distributed and the tax reporting system will store the one or more names and addresses of the third party(ies) with the relevant tax information. When the tax form is prepared for printing and distribution, the tax reporting system generates or instructs the generation of the tax form(s) for distribution to the designated third party(ies).

In at least one embodiment, the administrative tools screen may also provide a user with an option to instruct the tax reporting system to generate or instruct another system to generate a bar code on one or more tax forms, the bar code being used to designate one or more particular letter inserts to be provided with the tax form(s). In the administrative tools screen, the user can configure the bar code information to instruct a machine to package certain insert(s) with the tax form(s) before distribution to the customer (or other third party). For example, the user can designate that a second re-issued tax form receives a different insert than a first re-issued tax form.

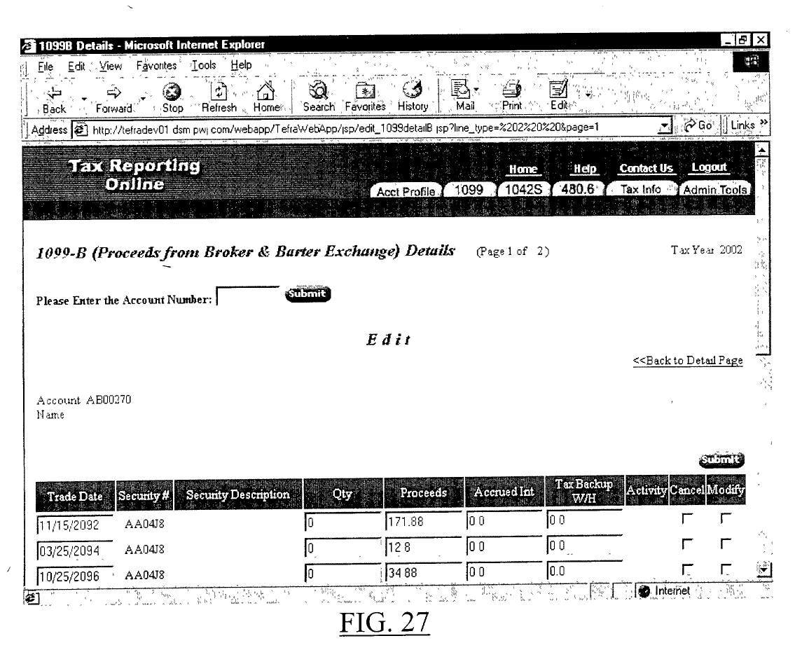

Referring to FIG. 27, in accordance with at least one embodiment of the invention, the tax reporting system may provide one or more tax form edit screens through which the user can perform certain editing functions of the tax information associated with and/or reported on a tax form. For example, the tax reporting system may provide summary and details edit screens for 1099, 1049S and 480.6A, B, C forms. In essence, these edit screens are the summary and details views of the tax form screen with the tax information pre-populated into data fields. The user can then edit the data in these fields and submit the edited information for inclusion in the tax information database. As described above, the tax reporting system manages the writing of the edited tax information into the tax information database. In FIG. 27, a details edit screen for the 1099-B form is depicted. As can be seen in FIG. 27, the screen fields are pre-populated with the transactional tax information pertaining to a selected account, namely example account AB00270, and related to the 1099-B form for that account. The user can edit the transactional tax information in the fields and indicate whether particular transactional tax information should be cancelled by clicking an associated “Cancel” checkbox. To update the edited tax information, the user clicks on the “Submit” button near the data fields. The user can change to a different account by entering a different account number in the account number field indicated and access the detailed transactional tax information of the 1099-B form for the desired account by clicking on the “Submit” button. As will be apparent, other similar screens may be provided for other tax forms.

In accordance with at least one embodiment, the tax reporting system may provide the capability for a user to search tax and/or investment information, using an ad hoc query screen displayed on the client, to generate one or more reports of tax and/or investment information for one or more accounts for one or more tax years. In at least one embodiment, the ad hoc query screen comprises one or more fields for a user to enter query terms and to configure the report(s) of the tax and/or investment information. For example, a user of the tax reporting system through the client would be able to isolate particular accounts, securities, taxpayer types (e.g., non-exempt holders for a particular security), etc. and view a report with the requested information for such accounts, securities, taxpayers types, etc. Further, a user of the tax reporting system through the client may be able to determine through a query provided in the ad hoc query screen, determine the number of accounts impacted by one or more corrections. So, for example, the user can determine the number of accounts to which only one correction has been made, determine the number of accounts to which two corrections have been made, and so on. With this information, the user can adjust the correspondence sent to particular customers or determine whether an adjustment should be processed.

The detailed descriptions may have been presented in terms of program procedures executed on a computer or network of computers. These procedural descriptions and representations are the means used by those skilled in the art to most effectively convey the substance of their work to others skilled in the art. The embodiments of the invention may be implemented as apparent to those skilled in the art in hardware or software, or any combination thereof. The actual software code or hardware used to implement the invention is not limiting of the invention. Thus, the operation and behavior of the embodiments often will be described without specific reference to the actual software code or hardware components. The absence of such specific references is feasible because it is clearly understood that artisans of ordinary skill would be able to design software and hardware to implement the embodiments of the invention based on the description herein with only a reasonable effort and without undue experimentation.

A procedure is here, and generally, conceived to be a self-consistent sequence of operations leading to a desired result. These operations comprise physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations of the invention described herein; the operations are machine operations. Useful machines for performing the operations of the invention include general purpose digital computers, special purpose computers or similar devices.

Each operation of the method may be executed on any general computer, such as a mainframe computer, personal computer or the like and pursuant to one or more, or a part of one or more, program modules or objects generated from any programming language, such as C++, Perl, Java, Fortran, etc. And still further, each operation, or a file, module, object or the like implementing each operation, may be executed by special purpose hardware or a circuit module designed for that purpose. For example, the invention may be implemented as a firmware program loaded into non-volatile storage or a software program loaded from or into a data storage medium as machine-readable code, such code being instructions executable by an array of logic elements such as a processor or other digital signal processing unit. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on.

In the case of diagrams depicted herein, they are provided by way of example. There may be variations to these diagrams or the operations described herein without departing from the spirit of the invention. For instance, in certain cases, the operations may be performed in differing order, or operations may be added, deleted or modified.

Embodiments of the invention may be implemented as an article of manufacture comprising a computer usable medium having computer readable program code means therein for executing the method operations of the invention, a program storage device readable by a machine, tangibly embodying a program of instructions executable by a machine to perform the method operations of the invention, or a computer program product. Such an article of manufacture, program storage device or computer program product may include, but is not limited to, CD-ROM, CD-R, CD-RW, diskettes, tapes, hard drives, computer system memory (e.g., RAM or ROM), and/or the electronic, magnetic, optical, biological or other similar embodiments of the program (including, but not limited to, a carrier wave modulated, or otherwise manipulated, to convey instructions that can be read, demodulated/decoded and executed by a computer). Indeed, the article of manufacture, program storage device or computer program product may include any solid or fluid transmission medium, whether magnetic, biological, optical, or the like, for storing or transmitting signals readable by a machine for controlling the operation of a general or special purpose computer according to any or all methods of the invention and/or to structure its components in accordance with a system of the invention.

Embodiments of the invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such as a cellular telephone).

The system may be specially constructed for the required purposes to perform, for example, the method of the invention or the system may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. The invention presented herein is not inherently related to a particular computer system or other apparatus. The required structure for a variety of these systems will appear from the description given.

While this invention has been described in relation to certain embodiments, it will be understood by those skilled in the art that other embodiments according to the generic principles disclosed herein, modifications to the disclosed embodiments and changes in the details of construction, arrangement of parts, compositions, processes, structures and materials selection all may be made without departing from the spirit and scope of the invention Changes, including equivalent structures, acts, materials, etc., may be made, within the purview of the appended claims, without departing from the scope and spirit of the invention in its aspects. Thus, it should be understood that the above described embodiments have been provided by way of example rather than as a limitation of the invention and that the specification and drawing(s) are, accordingly, to be regarded in an illustrative rather than a restrictive sense. As such, the invention is not intended to be limited to the embodiments shown above but rather is to be accorded the widest scope consistent with the principles and novel features disclosed in any fashion herein.

What is claimed is:

1. A method for tax reporting, the method comprising:
accessing a tax information database to retrieve aggregate tax reporting information and transactional tax reporting information corresponding to the aggregate tax reporting information;
displaying on a client a screen including the aggregate tax reporting information reported in a tax form; and
displaying on a client a screen including the transactional tax reporting information corresponding to the aggregate tax reporting information reported in the tax form.

2. The method of claim 1, wherein the tax form is at least one of an IRS 1099, 1042S and 480.6 tax form.

3. The method of claim 1, wherein at least one of the screen including the aggregate tax reporting information or the screen including the transactional tax reporting information includes at least one edit field including the tax reporting information and which the tax reporting information may be modified through the at least one edit field.

4. The method of claim 1, wherein the screen including the transactional tax reporting information includes:
a field that includes a tax year;
a field that includes an account identifier;
one or more fields arranged in a columnar manner including the transactional tax reporting information; and
at least one icon or interactive tab to switch to the screen including the aggregate tax reporting information.

5. The method of claim 1, wherein if a person corresponding to the transactional tax reporting information and the aggregate tax reporting information changes tax status in a tax year, dividing the transactional tax reporting information and the aggregate tax reporting information among screens corresponding to relevant tax forms based upon a change of tax status date.

6. The method of claim 1, further comprising adding a bar code to the tax form as printed to control packaging of inserts with the printed tax form.

7. The method of claim 1, further comprising displaying one or more screens including a field to designate a type of security reclassification, an input field to designate a security for reclassification, an input field to designate a payment type of the security to be reclassified, and an input field to select the parameters of the reclassification of the payment type of the security.

8. A tax reporting system, comprising:
a controller to process a request for a tax form screen;
a database accessor, invoked by the controller, to access a tax information database to retrieve aggregate tax reporting information and transactional tax reporting information corresponding to the aggregate tax reporting information;
a screen generator to generate the tax form screen for display on a client, a view of the tax form screen including the aggregate tax reporting information reported in a tax form and another view of the tax form screen including the transactional tax reporting information corresponding to the aggregate tax reporting information reported in the tax form.

9. The system of claim 8, wherein the tax form is at least one of an IRS 1099, 1042S and 480.6 tax form.

10. The system of claim 8, wherein at least one of the view of the tax form screen including the aggregate tax reporting information or the another view of the tax form screen including the transactional tax reporting information includes at least one edit field including the tax reporting information and which tax reporting information may be modified through the at least one edit field.

11. The system of claim 8, wherein the another view of the tax form screen including the transactional tax reporting information includes:
a field that includes a tax year;
a field that includes an account identifier;
one or more fields arranged in a columnar manner including the transactional tax reporting information; and
at least one icon or interactive tab to switch to the view of the tax form screen including the aggregate tax reporting information.

12. The system of claim 8, wherein if a person corresponding to the transactional tax reporting information and the aggregate tax reporting information changes tax status in a tax year, the tax reporting system is adapted to divide the transactional tax reporting information and the aggregate tax reporting information among screens corresponding to relevant tax forms based upon a change of tax status date.

13. The system of claim 8, wherein the tax reporting system is adapted to add a bar code to the tax form as printed to control packaging of inserts with the printed tax form.

14. The system of claim 8, wherein the database accessor is adapted to access a customers and accounts database, an investment advisors database and a securities database to retrieve investment information and the screen generator to generate the tax form screen for display on a client using the investment information.

15. A computer program product including computer program code to cause a processor to perform a method for tax reporting, the method comprising:
accessing a tax information database to retrieve aggregate tax reporting information and transactional tax reporting information corresponding to the aggregate tax reporting information;
displaying on a client a screen including the aggregate tax reporting information reported in a tax form; and
displaying on a client a screen including the transactional tax reporting information corresponding to the aggregate tax reporting information reported in the tax form.

16. The computer program product of claim 15, wherein the tax form is at least one of an IRS 1099, 1049S and 480.6 tax form.

17. The computer program product of claim 15, wherein the screen including the aggregate tax reporting information or the screen including the transactional tax reporting information includes at least one edit field including the tax reporting information and which tax reporting information may be modified through the at least one edit field.

18. The computer program product of claim 15, wherein the screen including the transactional tax reporting information includes:
a field that includes a tax year;
a field that includes an account identifier;
one or more fields arranged in a columnar manner including the transactional tax reporting information; and
at least one icon or interactive tab to switch to the screen including the aggregate tax reporting information.

19. The computer program product of claim 15, wherein if a person corresponding to the transactional tax reporting information and the aggregate tax reporting information changes tax status in a tax year, the method further comprising dividing the transactional tax reporting information and the aggregate tax reporting information among screens corresponding to relevant tax forms based upon a change of tax status date.

20. The computer program product of claim 15, the method further comprising adding a bar code to the tax form as printed to control packaging of inserts with the printed tax form.

21. The computer program product of claim 15, the method further comprising displaying one or more screens including a field to designate a type of security reclassification, an input field to designate a security for reclassification, an input field to designate a payment type of the security to be reclassified, and an input field to select the parameters of the reclassification of the payment type of the security.

22. A user interface for a tax reporting system, comprising a screen including:
a field that includes a tax year;
a field that includes an account identifier;
one or more fields including transactional tax reporting information corresponding to aggregate tax reporting information of a tax form; and
at least one icon or interactive tab to switch to a screen including the aggregate tax reporting information.

23. The user interface of claim 22, wherein the tax form is at least one of an IRS 1099, 1049S and 480.6 tax form.

24. The user interface of claim 22, wherein the screen further includes one or more interactive tabs to switch to one or more screens corresponding to one or more different tax forms.

25. The user interface of claim 22, wherein the screen further includes one or more interactive sub-tabs to switch to one or more screens corresponding to one or more different types of a tax form.

26. The user interface of claim 22, wherein the tax form is an IRS 1099-DIV tax form and the one or more fields including transactional tax reporting information include tax information regarding taxable exchanges of securities.

27. The user interface of claim 22, wherein the tax form is a non-reportable income tax form, the one or more fields including transactional tax reporting information include tax information regarding tax exempt distribution, and the non-reportable income tax form as printed includes the tax exempt distributions grouped by jurisdiction.

28. The user interface of claim 22, further comprising one or more screens including a field to designate a type of security reclassification, an input field to designate a security for reclassification, an input field to designate a payment type of the security to be reclassified, and an input field to select the parameters of the reclassification of the payment type of the security.

29. A tax reporting system, comprising:
means for accessing a tax information database to retrieve aggregate tax reporting information and transactional tax reporting information corresponding to the aggregate tax reporting information;
means for displaying on a client a screen including the aggregate tax reporting information reported in a tax form; and
means for displaying on a client a screen including the transactional tax reporting information corresponding to the aggregate tax reporting information reported in the tax form.

30. The system of claim 29, wherein the tax form is at least one of an IRS 1099, 1042S and 480.6 tax form.

31. The system of claim 29, wherein the screen including the aggregate tax reporting information or the screen including the transactional tax reporting information includes means for editing the tax reporting information.
